(19) United States
(12) Patent Application Publication
(10) Pub. No.: US 2026/0050958 A1
(43) Pub. Date: Feb. 19, 2026

(54) CUSTOMIZATIONS OF PHYSICAL NON-FUNGIBLE TOKENS TO REFLECT CUSTOMIZATIONS TO PHYSICAL COLLECTIBLES

(71) Applicant: Azuki Labs, Inc., Culver City, CA (US)

(72) Inventors: Qingyu Xu, Culver City, CA (US); Byron Tang, Culver City, CA (US); Conrad Chan, Culver City, CA (US); Cooper Mor, Culver City, CA (US); Andrey Kumanov, Culver City, CA (US)

(21) Appl. No.: 19/298,985

(22) Filed: Aug. 13, 2025

Related U.S. Application Data
(60) Provisional application No. 63/683,170, filed on Aug. 14, 2024.

(51) Int. Cl. G06Q 30/0601; G06F 16/22

(52) U.S. Cl. CPC G06Q 30/0621; G06F 16/2255

(57) ABSTRACT

Methods and apparatus are disclosed for customizing physical non-fungible tokens (NFTs) to reflect customizations to physical collectibles. A system includes database(s) configured to store image data indicative of a physical-backed NFT. The physical-backed NFT is a non-fungible token designated with a physical collectible. The system includes server(s) configured to retrieve recorded data from a blockchain. Upon identifying that a customization event is recorded on the blockchain, the server(s) are configured to store, in the database(s), the customization data that is associated with the customization event and included in the recorded data; identify and retrieve a digital customization that corresponds with the customization of the customization data retrieved from the blockchain; and create a customized physical-backed NFT that reflects a customized form of the physical collectible by modifying the physical-backed NFT with the digital customization.

### CROSS-REFERENCE TO RELATED APPLICATION

This application claims the benefit of U.S. Provisional Patent Application No. 63/683,170, filed Aug. 14, 2024, which is incorporated by reference herein in its entirety.

### TECHNICAL FIELD

The present disclosure generally relates to physical non-fungible tokens and, more specifically, to customizations of physical non-fungible tokens to reflect customizations to physical collectibles.

### BACKGROUND

The collectibles industry is worth hundreds of billions of dollars annually. Every year, collectors spend a vast amount of money on trading cards, coins, antiques, paintings, statues, figurines, classic cars, watches, sneakers, memorabilia (e.g., military memorabilia, sports memorabilia, movie memorabilia, etc.), signed phots, trinkets, plates, and other collectibles. The collectible industry is so developed and valuable that grading scales have been developed to judge and score the physical condition of a collectible (e.g., ranging from “poor” to “mint” condition). Additionally, there are appraisers that assess or verify the authenticity of and/or estimate the value of certain kinds of collectibles (e.g., art, antiques, etc.).

Non-fungible tokens (NFTs) have expanded the collectibles market into the digital world, with some NFTs having been sold for tens of millions of dollars. That is, NFTs are a type of collectible in digital form. NFTs are attractive to both collectors and creators for many reasons. For instance, NFTs may be more relatable to collectors that are digital natives. NFTs may also appeal to creators, such as artists, for being easier to set up direct sales with less involvement from intermediaries and/or brokers.

Recently, physical NFTs have been developed to connect the physical and digital worlds for collectibles. A physical NFT is an NFT that is linked to a specific physical object, such as a physical collectible. Physical NFTs have become attractive to some collectors as they facilitate the quick and easy authenticity and/or provenance of the physical collectibles. Physical NFTs may also enhance the user experience of collectors by providing both a digital experience for physical collectibles and a physical experience for digital collectibles.

That is, a physical NFT and its respective physical collectible may create an interconnection between the digital and physical worlds of the digital and physical collectibles. However, oftentimes that interconnection may be diminished if the appearance of a physical NFT does not reflect the appearance of the respective physical collectible. Moreover, even if the physical NFT is designed to reflect that of the respective physical collectible, the appearance of the physical NFT may no longer reflect that of the physical collectible the appearance of the physical collectible changes over time (e.g., due to damage, the addition of a signature, etc.). As a result, the attractiveness of some physical NFTs may be dampened as collectibles due to discrepancies that may arise between physical NFTs and respective physical collectibles due to the unfixed nature of physical objects.

### SUMMARY

Example embodiments are disclosed for customizations of physical non-fungible tokens to reflect customizations to physical collectibles. Disclosed herein are aspects of embodiments and should not be used to limit corresponding claims. Other implementations are contemplated in accordance with the teachings disclosed herein, as will be apparent to one having ordinary skill in the art upon examination of the following drawings and detailed description, and these implementations are intended to be within the scope of this application.

An example system for customizing physical-backed non-fungible tokens includes one or more databases configured to store image data indicative of a physical-backed non-fungible token. The physical-backed non-fungible token is a non-fungible token designated with a physical collectible. The image data includes data for a digital customization that reflects a customization made to the physical collectible The system includes one or more servers. The one or more servers is configured to receive, via a first mobile device of a collector, an identification code stored in a wireless tag of the physical collectible. The identification code is designated for both the physical collectible and the physical-backed non-fungible token. The one or more servers is configured to send the identification code to a collector smart contract to record a minting or transfer of the physical-backed non-fungible token on a blockchain; receive, via a second mobile device of an authorized customizer, customization data indicative of the customization made to the physical collectible by the authorized customizer during a customization event; send the customization data to a customizer smart contract to record the customization on the blockchain; and retrieve recorded data from the blockchain. Upon identifying that the customization event is recorded on the blockchain, the one or more servers is configured to store, in the one or more databases, the customization data that is associated with the customization event and included in the recorded data; identify and retrieve the digital customization that corresponds with the customization of the customization data retrieved from the blockchain; and create a customized physical-backed non-fungible token that reflects a customized form of the physical collectible by modifying the physical-backed non-fungible token with the digital customization.

An example method for customizing physical-backed non-fungible tokens includes storing, in one or more databases, image data indicative of a physical-backed non-fungible token. The physical-backed non-fungible token is a non-fungible token designated with a physical collectible. The image data includes data for a digital customization that reflects a customization made to the physical collectible. The method includes receiving, via one or more servers, an identification code stored in a wireless tag of the physical collectible from a first mobile device of a collector. The identification code is designated for both the physical collectible and the physical-backed non-fungible token. The method includes sending, via the one or more servers, the identification code to a collector smart contract to record a minting or transfer of the physical-backed non-fungible token on a blockchain and receiving, via the one or more servers, customization data from a second mobile device of an authorized customizer. The customization data is indicative of the customization made to the physical collectible by the authorized customizer during a customization event. The method includes sending, via the one or more servers, the customization data to a customizer smart contract to record the customization on the blockchain and retrieving, via the one or more servers, recorded data from the blockchain. The method, upon identifying that the customization event is recorded on the blockchain, includes storing, in the one or more databases, the customization data that is associated with the customization event and included in the recorded data; identifying and retrieving, via the one or more servers, the digital customization that corresponds with the customization of the customization data retrieved from the blockchain; and creating, via the one or more servers, a customized physical-backed non-fungible token that reflects a customized form of the physical collectible by modifying the physical-backed non-fungible token with the digital customization.

Example computer readable media includes instructions, which, when executed, cause one or more machines to collectively store image data indicative of a physical-backed non-fungible token. The physical-backed non-fungible token is a non-fungible token designated with a physical collectible. The image data includes data for a digital customization that reflects a customization made to the physical collectible. The instructions, when executed, cause the one or more machines to collectively receive an identification code stored in a wireless tag of the physical collectible from a first mobile device of a collector. The identification code is designated for both the physical collectible and the physical-backed non-fungible token. The instructions, when executed, cause the one or more machines to collectively send the identification code to a collector smart contract to record a minting or transfer of the physical-backed non-fungible token on a blockchain and receive customization data from a second mobile device of an authorized customizer. The customization data is indicative of the customization made to the physical collectible by the authorized customizer during a customization event. The instructions, when executed, cause the one or more machines to collectively send the customization data to a customizer smart contract to record the customization on the blockchain and retrieve recorded data from the blockchain. The instructions, when executed, cause the one or more machines, upon identifying that the customization event is recorded on the blockchain, to collectively store the customization data that is associated with the customization event and included in the recorded data; identify and retrieve the digital customization that corresponds with the customization of the customization data retrieved from the blockchain; and create a customized physical-backed non-fungible token that reflects a customized form of the physical collectible by modifying the physical-backed non-fungible token with the digital customization.

### BRIEF DESCRIPTION OF THE DRAWINGS

For a better understanding of the invention, reference may be made to embodiments shown in the following drawings. The components in the drawings are not necessarily to scale and related elements may be omitted, or, in some instances proportions may have been exaggerated to emphasize and clearly illustrate the novel features described herein. In addition, system components can be variously arranged, as known in the art. Further, in the drawings, like reference numerals designate corresponding parts throughout the several views.

FIG. 1 illustrates an example environment in which physical-backed non-fungible tokens (NFTs) are customized to reflect customizations to respective physical collectibles.

FIG. 2 depicts an example physical collectible associated with a respective physical-backed NFT.

FIG. 3 depicts a wireless tag of the physical collectible of the FIG. 2.

FIG. 4 depicts an example sequence for customizing a physical-backed NFT to reflect a customization of a respective physical collectible.

FIG. 5 further depicts the physical collectible of FIG. 2 with the wireless tag of FIG. 3.

FIG. 6 depicts a physical-backed NFT that is minted via a mobile device and linked to the physical collectible card of FIG. 2.

FIG. 7 further depicts the physical-backed NFT of FIG. 6.

FIG. 8 depicts a collectible customizer physically customizing the physical collectible of FIG. 2.

FIG. 9 depicts the collectible customizer taking a photo of the physical collectible as customized in FIG. 8.

FIG. 10 depicts the physical-backed NFT of FIG. 6 that has been customized to reflect the physical collectible as customize in FIG. 8.

FIG. 11 further depicts the customizations of the physical-backed NFT of FIG. 10.

FIG. 12 is a block diagram of components of an example system for customizing a physical non-fungible token to reflect a customization to a respective physical collectible.

FIG. 13 is a block diagram of components of an example server.

FIG. 14 is a block diagram of components of an example mobile device of a user.

FIG. 15 is a flowchart depicting an example method for operating a system to customize physical non-fungible tokens.

FIG. 16 is a flowchart depicting an example method for designating authorized customizations to a physical-backed NFT.

FIG. 17 is a flowchart depicting an example method for authorizing a collectible customizer to customize physical-backed NFTs.

FIG. 18 is a flowchart depicting an example method for having a physical-backed NFT minted and/or transferred via a blockchain.

FIG. 19 is a flowchart depicting an example method for generating image data and/or metadata of a customization made by an authorized customizer of a physical-backed NFT.

FIG. 20 is a flowchart depicting an example method for creating a customization and/or updating corresponding customization data of a physical-backed NFT.

### DETAILED DESCRIPTION

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

Example systems and methods disclosed herein customize previously minted physical non-fungible tokens to reflect customizations that have been made to their respective physical collectibles. More specifically, systems and methods disclosed herein make authorized customizations of authorized customizers to previously minted physical non-fungible tokens to reflect customizations that have been made to their respective physical collectibles. In turn, the systems and methods enable a physical-backed NFT to continue to reflect the respective physical collectible over time, even when the appearance of the physical collectible changes over time (e.g., due to damage, the addition of a signature, etc.).

To customize the physical-backed NFT to reflect the current condition and/or appearance of the respective physical collectible, the systems and methods designate authorized customizations and customizers for physical-backed NFTs; record and/or initiate the minting and/or transfer of the physical-backed NFTs on a blockchain; receive information of physical customizations from authorized customizers; subsequently generate and store image and/or other data (e.g., metadata) associated with the customizations of physical collectibles; index the blockchain for recorded minting, transfer, and/or customization events; and/or customize the physical NFTs and/or update corresponding information based on the stored data for those physical NFTs associated with identified customization events.

As a result, the systems and methods disclosed herein are necessarily rooted in computer technology, namely NFT and blockchain technology, to overcome a problem specifically arising in the realm of physical-backed NFTs. In particular, the systems and methods entail an unconventional technological solution of customizing previously minted physical-backed NFTs to match and/or resemble customizations of respective physical collectibles to address the technological problem of physical-backed NFTs not reflecting the respective physical collectibles as the physical state of those physical collectibles changes over time.

As used herein, a “collectible” refers to something that is regarded as being of value or interest to a collector.

As used herein, a “collector” and a “collecting user” refer to a person who collects collectibles. Example collectibles may be physical collectibles or digital collectibles.

As used herein, a “physical collectible” refers to a physical object that is a collectible. Example physical collectibles include collectible or trading cards (e.g., sports cards, anime cards, etc.), stamps, coins, figurines, etc. Example physical collectibles also include “memorabilia,” which refers to items originally created for a particular purpose that have since derived value to a collector outside of that particular purpose (e.g., a ticket to a famous sporting event).

As used herein, a “digital collectible” refers to a digital item that is a collectible. Example digital collectibles include non-fungible tokens.

As used herein, a “non-fungible token” and an “NFT” refer to a data file with a unique digital identification code that is recorded on a blockchain to designate authenticity and ownership of a corresponding unique digital asset. NFTs are non-fungible in that each NFT is uniquely identifiable.

As used herein, a “blockchain” refers to a distributed ledger with blocks that are securely maintained via cryptographic hashes. Each block (or “record”) of a blockchain may contain a cryptographic hash of the previous block in the ledger. Some blockchains use secured using cryptographic keys and signatures. Each block of may also contain other data, such as a timestamp, transactional data, and/or other data associated with NFTs, objects, and/or recorded events. Transactional data may be indicative of a minting and/or a transfer of an NFT.

As used herein, “asymmetric cryptography” refers to a type of cryptography in which both a public key and a private key are used to securely send and receive data. For example, a private key may be used to sign messages and decrypt data, and a public key may be used to validate signatures and encrypt data. With respect to a transaction recorded on a blockchain, a user may have to digitally sign the transaction with their private key that is stored in their digital wallet. Once the transaction is sent onto the blockchain network, the user's signature is verified with a corresponding public key to prove that the transaction has been authorized.

As used herein, a “digital wallet” and an “NFT wallet” refer to hardware and/or software in which private keys and/or other data for NFTs may be securely stored for a user. Example digital wallets include an app or web portal that is accessible online.

As used herein, to “mint” an NFT refers to creating an NFT on a blockchain. NFTs may be minted on a blockchain via a smart contract.

As used herein, a “smart contract” refers to a computer program and/or a transaction protocol that is configured to automatically execute events associated with the blockchain according to predefined terms or agreements. A smart contract of a blockchain may be configured to mint, transfer, and/or otherwise assign ownership of an NFT, such as a physical-backed NFT.

As used herein, a “physical-backed non-fungible token,” a “physical-backed NFT,” a “physical non-fungible token,” a “physical NFT,” and “PBT” refer to an NFT that is designated to correspond with a respective unique physical object, such as a physical collectible. That is, one physical-backed NFT is designated to correspond with one unique physical collectible, and that one unique physical collectible is designated to correspond with that one physical-backed NFT.

As used herein, a “customizer,” “collectible customizer,” and a “customizing user” refer to a person who customizes a previously issued physical collectible. An example customizer may be a person who signs a physical collectible with their signature. Such a customizer may be an artist, author, creator, actor, and/or other person associated with the physical collectible. Another example customizer may be collectible grader who grades the condition and quality of a physical collectible.

As used herein, “customization data” refers to data indicative of a customization of a physical collectible (e.g., a signature, a grading, etc.) that corresponds with a respective physical-backed NFT. The customization data may include image data (e.g., of a signature), metadata, and/or other data (e.g., a grading) that is recorded on the blockchain to associate the customization of the physical collectible with its respective physical-backed NFT.

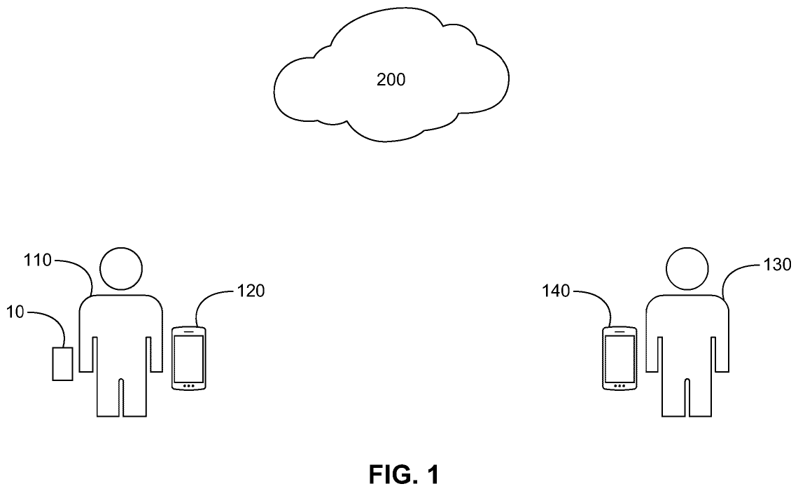

Turning to the figures, FIG. 1 illustrates an example environment in which a PBT system 200 customizes physical-backed NFTs of collectors to reflect customizations made by customizers to respective physical collectibles. FIG. 1 depicts one collector with one physical collectible that corresponds with a physical-backed NFT (e.g., a physical-backed NFT 30 of FIGS. 6-7), and one customizer that is capable customizing the physical collectible. However, the PBT system 200 is configured to customize physical-backed NFTs of one or more collectors, with each collecting possessing one or more collectables, to reflect the customizations made to those physical collectibles by one or more customizers. That is, FIG. 1 depicts one collector, one physical collectible, and one customizer to simplify the description of the capabilities of the PBT system 200 to customize physical-backed NFTs to reflect customizations made to the respective physical collectibles and is not intended to limit the scale of the PBT system 200.

As illustrated in FIG. 1, the collector 110 possesses the physical collectible 10 and a mobile device 120, and the customizer 130 has a mobile device 140. Each of the mobile devices 120, 140 are configured to wirelessly communicate with the PBT system 200 to enable the PBT system 200 to customize a physical-backed NFT to reflect the current physical state of the physical collectible 10. In the illustrated example, each of the mobile devices 120, 140 is a smartphone. In other examples, one or more of the mobile devices 120, 140 may be a tablet, a smartwatch, and/or any other computing device capable of accessing a social media platform. In yet other examples, other computing devices, such as laptops and/or desktops, of the collector 110 and/or the customizer 130 may be used to communicate with the PBT system 200.

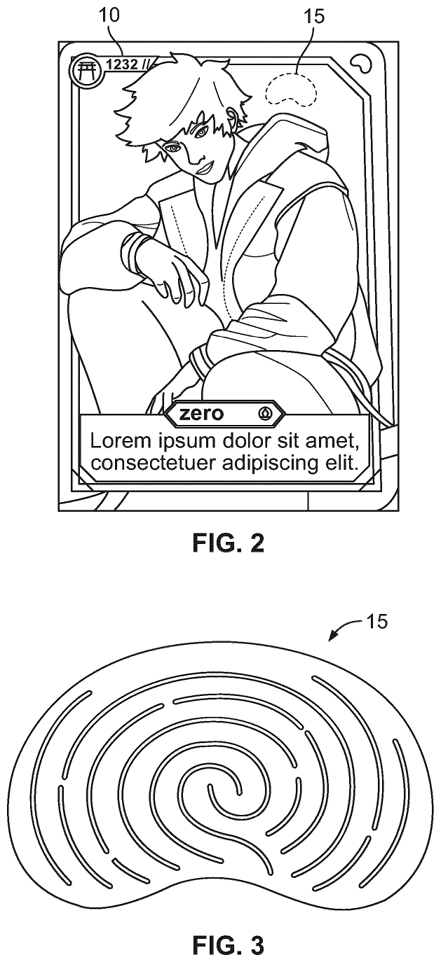

FIG. 2 further depicts an example of the physical collectible 10. In FIG. 2, the physical collectible 10 is a collectible or trading card. In other examples, physical collectible 10 may be a stamp, a coin, a figurine, and/or any other type of physical collectible. The physical collectible 10 includes a wireless tag 15, which is further depicted in FIG. 3. The wireless tag 15 may be imbedded in, stamped on, and/or otherwise fixed to a portion of a body of the physical collectible 10. As disclosed below in greater detail, the wireless tag 15 is configured to store digital identification data (e.g., an ID code) that is designated to identify the physical collectible 10 and/or the respective physical-backed NFT 30 (FIGS. 6-7). The wireless tag 15 is configured to wirelessly transmit the identification code a mobile device (e.g., the mobile device 120, the mobile device 140, etc.) when the mobile device is positioned within range of and/or is communicatively paired with the wireless tag 15. That is, the mobile device 120 of the collector 110 and/or the mobile device 140 of the customizer 130 is configured to wirelessly receive the identification code designated for the physical collectible 10 and/or the respective physical-backed NFT 30 when the mobile device 120, 140 is positioned within range of and/or is communicatively paired with the wireless tag 15. In some examples, the wireless tag 15 is a near-field communication (NFC) tag with a transmitter configured to wirelessly communicate via NFC. Additionally or alternatively, the wireless tag 15 may be any other type of wireless tag, such as a radio-frequency identification (RFID) tag (e.g., a passive RFID tag), capable of wirelessly communicating the identification code to the mobile devices 120, 140.

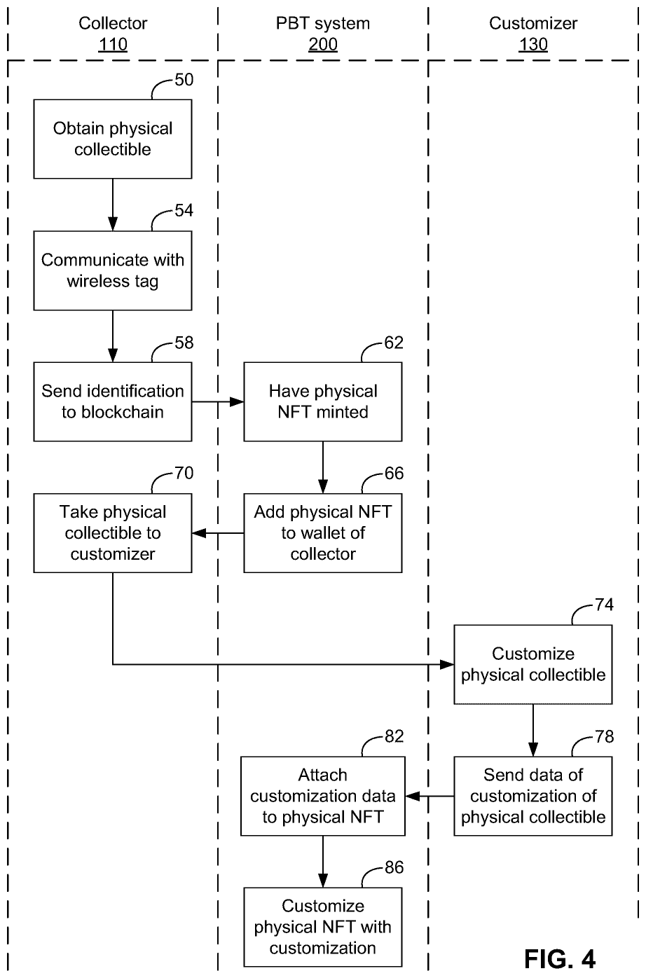

Turning to FIG. 4, an example sequence is depicted for customizing a physical-backed NFT to reflect a customization of a respective physical collectible.

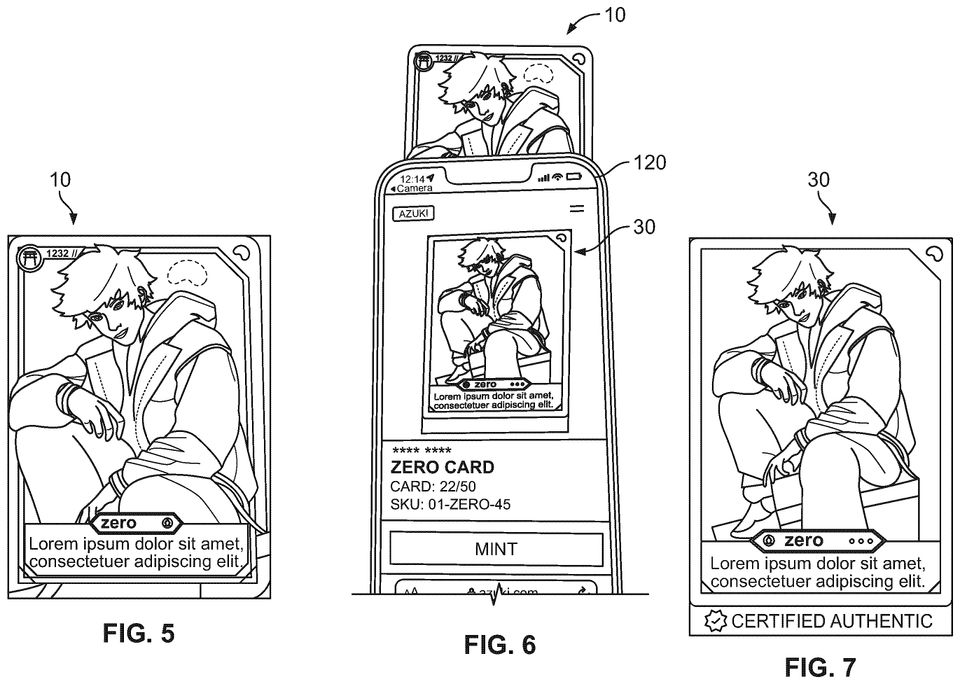

At step 50, the collector 110 obtains possession of the physical collectible 10. FIG. 5 further depicts an example of the physical collectible 10. In the illustrated example, the physical collectible 10 is a collectible or trading card. In other examples, physical collectible 10 may be a stamp, a coin, a figurine, and/or any other type of physical collectible. Returning to step 54 of FIG. 4, the mobile device 120 of the collector 110 wirelessly communicates with the wireless tag 15 of the physical collectible 10 to obtain identification code designated for the physical collectible and the respective physical-backed NFT 30. FIG. 6, depicts the mobile device 120 of the collector 110 positioned directly near the physical collectible 10 to be in wireless communication with the wireless tag 15 of the physical collectible 10. More specifically, FIG. 6 depicts the mobile device 120 displaying a preview of the physical-backed NFT 30 after the mobile device 120 has received the identification code from the wireless tag 15.

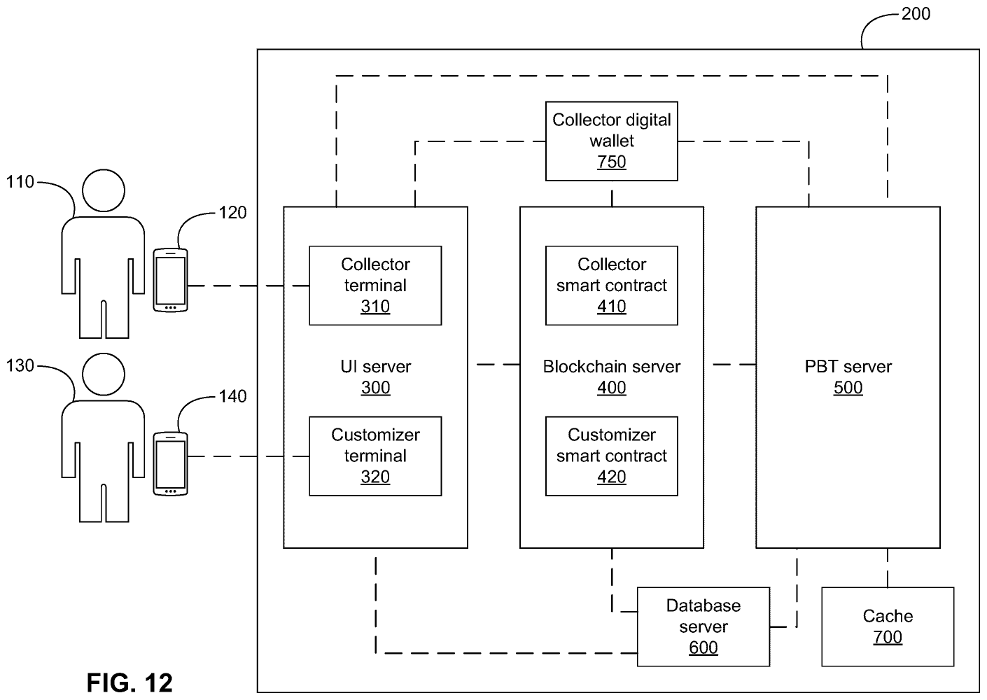

Returning to step 58 of FIG. 4, the mobile device 120 of the collector 110 sends (e.g., via wireless communication) the identification code designated for the physical collectible 10 and the physical-backed NFT 30 to the PBT system 200. At step 62, the PBT system 200 has the physical-backed NFT 30 minted. FIG. 7 depicts the physical-backed NFT 30 that has been minted. Returning to step 66 of FIG. 4, the PBT system 200 has the physical-backed NFT 30 added to the digital wallet (e.g., a digital wallet 750 of FIG. 12) of the collector 110 for secure storage.

At step 70, the collector 110 takes the physical collectible 10 to the customizer 130. At block 74, the customizer 130 customizes the physical collectible 10 with a customization 25 to create a customized physical collectible 20. That is, the physical collectible 10 in FIGS. 2 and 5-6 is a “non-customized physical collectible” or a “pre-customized physical collectible” that has not been and/or has yet to be customized by a customizer 130. The customized physical collectible 20 is the physical collectible 10 after it has been customized by the customizer 130.

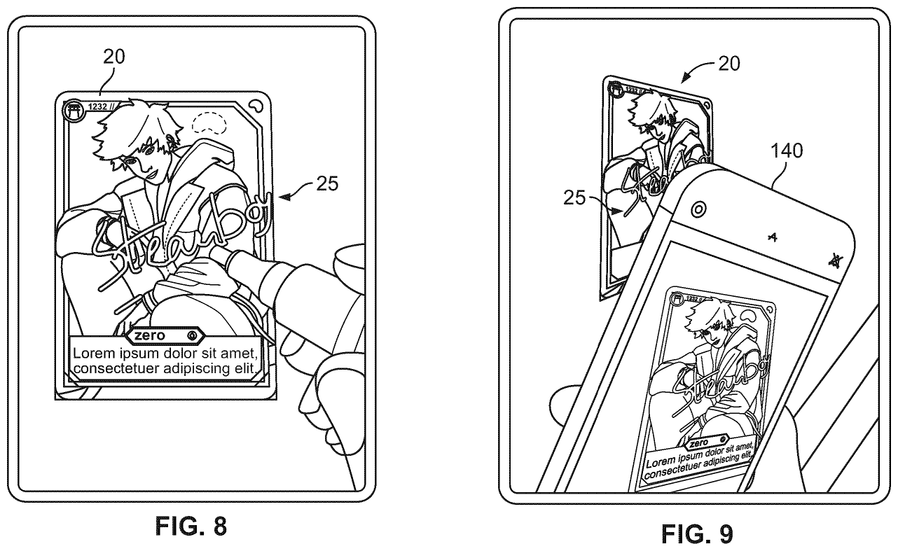

In the illustrated example of FIG. 8, the customization 25 is a signature of the customizer 130. Additionally or alternatively, the customization 25 may include and/or correspond with the generation of customization data. For example, the customization 25 may include customization data that includes image data for a customization of the corresponding physical-backed NFT 30. The image data may include data for a digital customization of the physical-backed NFT 30 that reflects a customization made to the physical collectible 10. In other examples, the customization 25 includes other data, such as a grading score of the physical collectible 10, that is subsequently recorded on the blockchain to associate the customization of the physical collectible 10 with the respective physical-backed NFT 30.

Returning to step 78 of FIG. 4, the customizer 130 sends the customization data (e.g., image data, scoring data, metadata, etc.) to the PBT system 200. For example, the mobile device 140 obtains the customization data from the customizer 130 and wirelessly sends the customization data to the PBT system 200. In FIG. 9, the mobile device 140 of the customizer 130 captures a photo of the customized physical collectible 20 with the corresponding customization 25 and subsequently sends the corresponding image data, as customization data, to the PBT system 200. In other examples in which the customization 25 corresponds with a grading score, the mobile device 140 collects the grading score from the customizer 130 via a corresponding interface on the mobile device 140 and subsequently sends the corresponding grading data, as customization data, to the PBT system 200.

Returning to step 82 of FIG. 4, the PBT system 200 attaches the customization data to the physical-backed NFT 30 by storing the customization data and having the customization recorded on the blockchain. At block 86, the PBT system customizes the physical-backed NFT 30 with a digital customization 45 to create a customized physical-backed NFT 40. That is, the physical-backed NFT 30 in FIGS. 6-7 is a “non-customized physical-backed NFT” or a “pre-customized physical-backed NFT” that has not been and/or has yet to be customized by the PBT system 200. The customized physical-backed NFT 40 is the physical-backed NFT 30 after it has been customized by the PBT system 200. The digital customization 45 matches, resembles and/or reflects the customization 25 so that customized physical-backed NFT 40 is reflective of the current physical state of the customized physical collectible 20.

Turning to FIG. 12, a block diagram of example components of the PBT system 200 is depicted. In the illustrated example, the PBT system 200 includes a user interface (UI) server 300, a blockchain server 400, a PBT server 500, a database server 600, a cache 700, and a digital wallet 750.

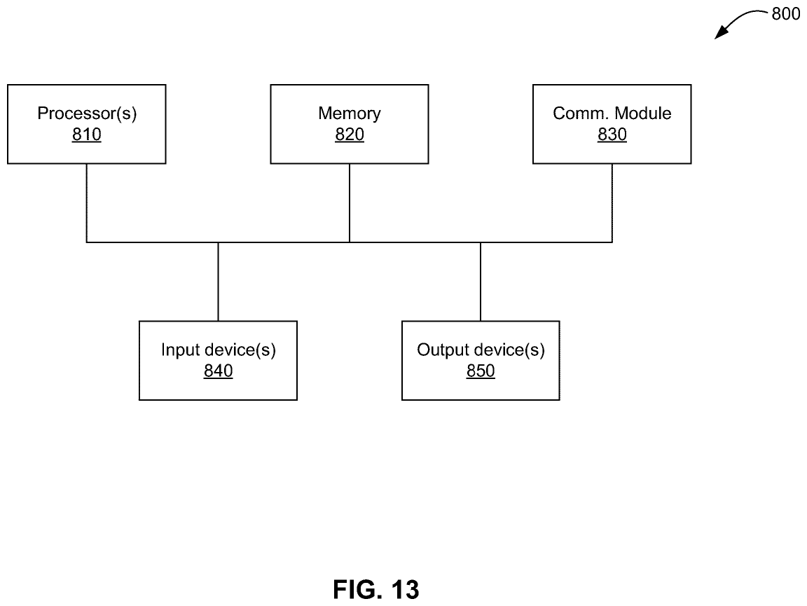

Each of the UI server 300, the blockchain server 400, the PBT server 500, and the database server 600 may include components of an example server 800 of FIG. 13. As illustrated in FIG. 13, the server 800 includes one or more processors 810, memory 820, a communication module 830, one or more input devices 840, and one or more output devices 850. That is, each of the UI server 300, the blockchain server 400, the PBT server 500, and/or the database server 600 may include processor(s) 810, memory 820, a communication module 830, input device(s) 840, and output device(s) 850, as depicted in FIG. 13.

The processor(s) 810 may be any suitable processing device or set of processing devices such as, but not limited to, a microprocessor, a microcontroller-based platform, an integrated circuit, etc. The memory 820 may include one or more of volatile memory, non-volatile memory, read-only memory, etc. In some examples, the memory 820 may include a combination of multiple kinds of memory, such as volatile memory and non-volatile memory. The memory 820 is computer readable media on which one or more sets of instructions, such as the software for operating the methods of the instant disclosure, can be embedded. The instructions may embody one or more of the methods or logic as described herein. For example, the instructions reside completely, or at least partially, within any one or more of the memory 820, the computer readable medium, and/or within the processor(s) 810 during execution of the instructions.

The terms “non-transitory computer-readable medium” and “computer-readable medium” include a single medium or multiple media, such as a centralized or distributed database, and/or associated caches and servers that store one or more sets of instructions. Further, the terms “non-transitory computer-readable medium” and “computer-readable medium” include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

The communication module 830 is configured to enable wireless and/or wired communication with network(s) and/or other device(s) (e.g., other server(s); mobile device(s) such as the mobile devices 120, 140; etc.). The network may be a public network, such as the Internet; a private network, such as an intranet; or combinations thereof. The network may utilize a variety of networking protocols. As used herein, the term “module” refers to hardware with circuitry to provide communication, control and/or monitoring capabilities. A “module” may also include firmware that executes on the circuitry.

In the illustrated example, the communication module 830 includes wireless and/or wired network interfaces to enable communication with the network(s) and/or computing device(s). The communication module 830 also includes hardware (e.g., processors, memory, storage, antenna, etc.) and software to control the wireless and/or wired network interfaces. For example, the communication module 830 includes hardware, software, and network interfaces for communication via cellular network(s), such as Long-Term Evolution (LTE). Additionally or alternatively, the communication module 830 includes hardware, software, and network interfaces for communication via wireless local area networks (WLANs), such as Wi-Fi®; wireless personal area network (WPANs), such as Bluetooth® and/or Bluetooth® Low Energy (BLE); etc.

The input device(s) 840 enable an operator, such as an information technician or analyst of, to provide instructions, commands, and/or data to the processor(s) 810. Additionally or alternatively, the input device(s) 840 enable the operator to modify and/or update the instructions stored in the memory 820. Example input device(s) 840 include a keyboard, a mouse, a touchscreen, a touchpad, a speech recognition system, an instrument panel, button(s), control knob(s), etc.

The output device(s) 850 display output information and/or data of the server 800 to an operator, such as an information technician or analyst. Example output device(s) 850 include a liquid crystal display (LCD), an organic light emitting diode (OLED) display, a flat panel display, a solid-state display, and/or any other device that visually presents information to a user. Additionally or alternatively, the output device(s) 850 may include one or more speakers and/or any other device(s) that provide audio output signals for the operator. Further, the output device(s) 850 may provide other types of output information, such as haptic signals.

Returning to FIG. 12, the UI server 300 is a frontend server that is configured to communicate with the collector 110 via a web portal, app, and/or another user interface operating on the mobile device 120 of the collector 110. For example, the UI server 300 is configured to collect identification data of the wireless tag 15 from the mobile device 120 of the collector 110. The UI server 300 also is configured to provide images of the physical-backed NFT 30, the customized physical-backed NFT 40, and/or the customized physical collectible 20 to the mobile device 120 upon request by the collector 110. The UI server 300 also is configured to communicate with the customizer 130 via a web portal, app, and/or another user interface operating on the mobile device 140 of the customizer 130. For example, the UI server 300 is configured to collect customization data associated with the customized physical collectible 20 from the mobile device 140 of the customizer 130.

In the illustrated example, the UI server 300 includes a collector terminal 310 and a customizer terminal 320. That is, the collector terminal 310 and the customizer terminal 320 are depicted as separate terminals. In other examples, the collector terminal 310 and the customizer terminal 320 may form a single terminal for communication with both the collector 110 and the customizer 130. Further, in some examples, the web portal app and/or other user interface for the collector 110 may be different than, the same as, and/or combined with that for the customizer 130. As depicted in FIG. 12, the collector terminal 310 is configured to wirelessly communicate with the mobile device 120 of the collector 110, and the customizer terminal 320 is configured to wirelessly communicate with the mobile device 140 of the customizer 130.

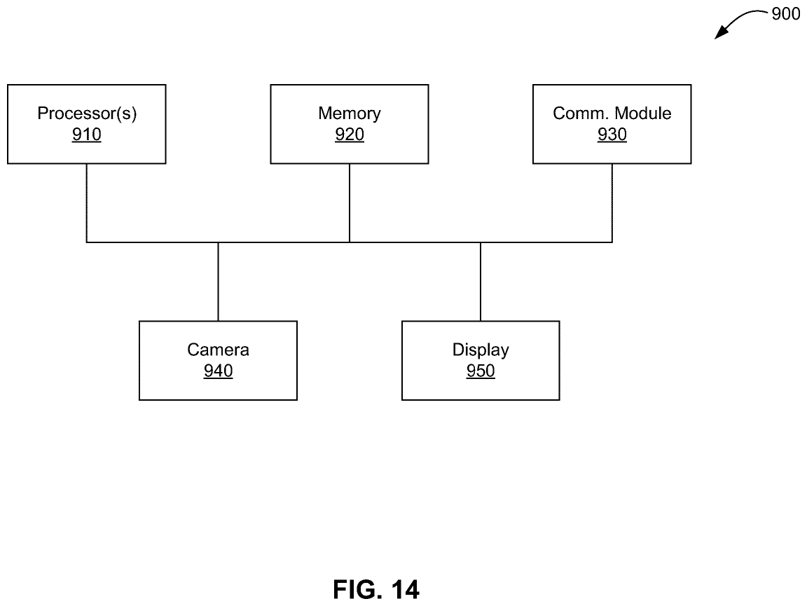

Each of the mobile devices 120, 140 include components that facilitate customization of physical-backed NFTs. Turning to FIG. 14, a block diagram of components of an example mobile device 900 is depicted. In the illustrated example, the mobile device 900 includes one or more processors 910, memory 920, a communication module 930, a camera 940, and a display 950. That is, each of the mobile devices 120, 140 may include processor(s) 910, memory 920, a communication module 930, a camera 940, a display 950, and/or other input/output devices, as depicted in FIG. 14.

The processor(s) 910 may be any suitable processing device or set of processing devices such as, but not limited to, a microprocessor, a microcontroller-based platform, an integrated circuit, etc. The memory 920 may include one or more of volatile memory, non-volatile memory, read-only memory, etc. In some examples, the memory 920 may include a combination of multiple kinds of memory, such as volatile memory and non-volatile memory. The memory 920 is computer readable media on which one or more sets of instructions, such as the software for operating the methods of the instant disclosure, can be embedded. The instructions may embody one or more of the methods or logic as described herein. For example, the instructions reside completely, or at least partially, within any one or more of the memory 920, the computer readable medium, and/or within the processor(s) 910 during execution of the instructions.

The communication module 930 is configured to enable wireless and/or wired communication with network(s) and/or other device(s) (e.g., the wireless tag 15 of the physical collectible 10; the servers 300, 400, 500; etc.). The network may be a public network, such as the Internet; a private network, such as an intranet; or combinations thereof. The network may utilize a variety of networking protocols. The communication module 930 includes wireless and/or wired network interfaces to enable communication with the network(s) and/or other computing device(s). The communication module 930 also includes hardware (e.g., processors, memory, storage, antenna, etc.) and software to control the wireless and/or wired network interfaces.

The communication module 930 includes hardware, software, and/or interfaces to receive information associated with a physical collectible from a corresponding wireless tag (e.g., the wireless tag 15 of the physical collectible 10), for example, via near-field communication (NFC), radio-frequency identification (RFID, etc. The communication module 930 includes hardware, software, and/or network interfaces to communicate with the PBT system 200 (e.g., the UI server 300 of the PBT system 200) via cellular network(s) such as Long-Term Evolution (LTE), 4G, 5G, etc. Additionally or alternatively, the communication module 830 includes hardware, software, and/or network interfaces for communication via wireless local area networks (WLANs), such as Wi-Fi®; wireless personal area network (WPANs), such as Bluetooth® and/or Bluetooth® Low Energy (BLE); etc.

The camera 940 of the illustrated example is configured to capture an image and/or video of the physical collectible 10. For example, the camera 940 of the mobile device 120 of the collector 110 and/or the mobile device 140 of the customizer 130 is configured to capture an image and/or video of the physical collectible 10 and/or the customized physical collectible 20. One or more of the mobile device(s) 900 may also include other input device(s), such as a keyboard, a mouse, a touchscreen, a touchpad, a speech recognition system, an instrument panel, button(s), control knob(s), etc.

The display 950 of the illustrated example is configured to present an image and/or video of the physical collectible 10. For example, the display 950 of the mobile device 120 of the collector 110 and/or the mobile device 140 of the customizer 130 is configured to present an image and/or video of the physical collectible 10 and/or the customized physical collectible 20. The display 950 may include a liquid crystal display (LCD), an organic light emitting diode (OLED) display, a flat panel display, a solid-state display, and/or any other device that visually presents information to a user. One or more of the mobile device(s) 900 may also include other output device(s), such as speaker(s), haptic output device(s), etc.

Returning to FIG. 12, the collector terminal 310 is configured to collect information from and/or present information to the collector 110 via a web portal, app, and/or another user interface associated with PBTs that is operating on the mobile device 120. For example, the collector terminal 310 is configured to collect identification data for a respective physical-backed NFT from the mobile device 120 upon (1) the collector 110 possessing the physical collectible 10, (2) the mobile device 120 communicatively pairing to the wireless tag 15 of the physical collectible 10, (3) the collector 110 opening the PBT user interface on the mobile device 120, and (4) the mobile device 120 sending the identification data to the collector terminal 310 via wireless communication. That is, the collector terminal 310 of the UI server 300 is configured to receive, via the mobile device 120 of the collector 110, an identification code that is stored in the wireless tag 15 of the physical collectible 10. The identification code is designated for both the physical collectible 10 and the physical-backed NFT 30. Further, the collector terminal 310 of the UI server 300 is configured to receive the identification code via wireless communication with the mobile device 120 upon the mobile device 120 previously receiving the identification code via wireless communication with the wireless 14 tag of the physical collectible 10.

The collector terminal 310 also is configured to facilitate presentation of a physical-backed NFT to the collector 110 by (1) receiving a request for presentation of the physical-backed NFT from the collector 110 via the PBT user interface, (2) retrieving an identification code (e.g., a URI) associated with the physical-backed NFT from the digital wallet 750 of the collector 110, (3) retrieving image and/or other data associated with the requested physical-backed NFT (e.g., from the database server 600) based on the previously-retrieved identification code, and (4) providing the image and/or other data of the requested physical-backed NFT to the mobile device 120 for presentation to the collector 110 via the display 950 and the user interface operating on the mobile device 120. That is, the collector terminal 310 of the UI server 300 is configured to provide an image of the customized physical-backed NFT 40, which reflects the customized physical collectible 20, to the mobile device 120 for presentation to the collector 110.

The customizer terminal 320 is configured to collect information from and/or present information to the customizer 130 via a web portal, app, and/or another user interface associated with PBTs that is operating on the mobile device 140. For example, the customizer terminal 320 is configured to collect identification information of the customizer 130 that is analyzed to sanction the customizer 130 as an authorized customer and/or to identify which physical collectible(s) the customizer 130 is authorized to customize. The customizer terminal 320 is configured to collect customization data (e.g., an image of a signature) of the customizer 130 that is subsequently used to customize a physical-backed NFT for which the customizer 130 is authorized to customize. The customizer terminal 320 is configured to collect identification data for a respective physical-backed NFT from the mobile device 120 upon (1) the mobile device 140 communicatively pairing to the wireless tag 15 of the physical collectible 10 and/or (2) the customizer 130 capturing an image and/or a video of the physical collectible 10 via the camera 940 of the mobile device 140. The customizer terminal 320 is configured to collect an image that has been captured by the camera 940 of the mobile device 140 of a physical-backed NFT that has been modified by the customizer 130. The customizer terminal 320 is configured to collect image data and/or metadata (e.g., a timestamp, a location, etc.) associated with the customization of the physical-backed NFT. That is, the customizer terminal 320 of the UI server 300 is configured to receive, via the mobile device 140, customization data indicative of a customization made to the physical collectible 10 by the customizer 130 during a customization event.

The blockchain server 400 of FIG. 12 is configured to operate the blockchain on which the physical-backed NFTs are stored. In the illustrated example, the blockchain server 400 includes a collector smart contract 410 and a customizer smart contract 420.

The collector smart contract 410 is a computer program and/or transaction protocol that is configured to mint, transfer, and/or otherwise assign ownership of a physical-backed NFT. For example, the collector smart contract 410 is configured to automatically mint, transfer, and/or otherwise assign ownership of the physical-backed NFT 30 associated with the physical collectible 10 upon (1) receiving identification information of the physical-backed NFT 30 that originated from the wireless tag 15 of the physical collectible 10 and (2) receiving a private key of the collector 110 from the digital wallet 750 of the collector 110 to digitally sign the transaction. The collector terminal 310 of the UI server 300 is configured to send the identification code to the collector smart contract 410 of the blockchain server 400 to record a minting or transfer of the physical-backed NFT 30 on the blockchain.

The blockchain server 400 is configured to record the physical-backed NFT and data (e.g., an identification code) indicative of its mint, transfer, and/or ownership on a blockchain. Further, in response to the minting of a physical-backed NFT, the collector smart contract 410 and/or the blockchain server 400 is configured to send an identification code of the physical-backed NFT, such as uniform resource identifier (URI), to the database server 600 for subsequent storage. The collector smart contract 410 and/or the blockchain server 400 also is configured to send an identification code (e.g., the URI) to the digital wallet 750 of the collector 110 to facilitate subsequent retrieval of an image of the physical-backed NFT for the collector 110.

The digital wallet 750 is configured to store private key(s) and/or other data associated with NFTs (e.g., physical-backed NFTs), cryptocurrency and/or other digital assets of the collector 110 that are recorded on a blockchain. For example, the digital wallet 750 securely store private key(s) of asymmetric cryptography that are used for the physical-backed NFTs.

The customizer smart contract 420 is a computer program and/or transaction protocol that is configured to record metadata indicative of a customization event of a physical-backed NFT. For example, the customizer smart contract 420 is configured to automatically record a customization of the physical collectible 10 associated with the physical-backed NFT 30 upon (1) receiving customization data from the customizer 130 and (2) confirming that the customizer 130 is authorized to customize the physical-backed NFT 30 with the identified customization. That is, the customizer terminal 320 of the UI server 300 is configured to send the customization data to the customizer smart contract 420, which is configured to record the customization and the corresponding customization data on the blockchain. The customization data is associated with the customization of the physical collectible 10 on the blockchain and enables the corresponding physical-backed NFT 30 to be customized in a manner that reflects the customization of the physical collectible 10.

The PBT server 500 of FIG. 12 is a backend server that is configured to manage the ownership and customization of physical-backed NFTs. The PBT server 500 is configured to (1) designate authorized customizations for physical-backed NFTs and authorized customizers for those customizations, (2) index the blockchain for minting, transfer, and/or customization events of physical-backed NFTs; (3) retrieve data (e.g., image data, metadata, and/or other data) associated with those events from the blockchain; and (4) store the retrieved data in the database server 600 to facilitate subsequent presentation of the physical-backed NFTs. That is, the database server 600 includes one or more databases in which identification, image, customization, and/or other NFT-related data (e.g., metadata) are stored to facilitate subsequent presentation of physical-backed NFTs (e.g., customized physical-backed NFTs) to respective collectors. For example, the one or more databases of the PBT system 200 is configured to store image data indicative of a physical-backed NFTs.

In the illustrated example, the PBT server 500 is configured to (1) identify when new physical-backed NFTs have been released and (2) designate customizations that have been authorized for those physical-backed NFTs. The PBT server 500 may store data associated with the released physical-backed NFTs and/or the authorized customizations in the database server 600. In some examples, the PBT server 500 identifies which physical-backed NFTs are authorized to be customized and/or which customizations are authorized for those physical-backed NFTs based on information collected by the PBT server 500 from the creator of the physical-backed NFTs. The authorized customizations are designed and configured to enable the physical-backed NFTs to be customized in a manner that reflect the current condition and/or appearance of respective physical collectibles by matching and/or resembling customizations that have been made to those respective physical collectibles.

The PBT server 500 also is configured authorize customizers for customizing the physical-backed NFTs. The PBT server 500 may store data associated with the authorized customizer, such data indicative of which physical-backed NFTs the customizer is authorized to customize and/or which customizations the customizer is authorized to make for each of those physical-backed NFTs. In some examples, the PBT server 500 authorizes customizers and/or which customizations those customizers are authorized to make based on information collected by the PBT server 500 from the customizers and/or the creator of the physical-backed NFTs. For example, a creator of physical-backed NFTs may indicate to the PBT server 500 which customizers are authorized to customize their physical-backed NFTs, which customizations those customizers are authorized to make, and to which specific physical-backed NFTs. The PBT server 500 may collect information from a customizer to authenticate that the customizer is authorized by the creator of the physical-backed NFT to customize that physical-backed NFT.

The PBT server 500 is configured to index the cache 700 to determine whether the latest block in the blockchain has already been indexed by the PBT server 500. If the data stored in the cache 700 indicates latest block in the blockchain has already been indexed, the PBT server 500 does not index the blockchain for the data recorded in the latest block. The PBT server 500 indexes the blockchain for the data recorded in the latest block only when the data in the cache 700 indicates that the PBT server 500 has yet to do so for that block. That is, to retrieve recorded data from the blockchain, the PBT server 500 is configured to (1) index the blockchain to identify a most recent block in the blockchain, (2) index the cache 700 to identify whether the most recent block in the blockchain has already been indexed, and (3) retrieve the recorded data from the most recent block in the blockchain in response to determining that the most recent block has yet to be indexed. The cache 700 is configured to prevent the PBT server 500 from repeatedly indexing the same block of information from the blockchain.

The PBT server 500 also is configured to index the blockchain for mint, transfer, and/or customization data of physical-backed NFTs that are recorded in the latest block of the blockchain. That is, the PBT server 500 is configured to retrieve data recorded on the blockchain. For example, the PBT server 500 is configured identify and retrieve mint data (e.g., an identification code such as a URI) associated with the minting of a physical-backed NFT and/or transfer data (e.g., with a URI) associated with the transfer of a physical-backed NFT from one collector to another that was recorded in the latest block of the blockchain. Additionally or alternatively, the PBT server 500 is configured identify and retrieve customization data (e.g., image data, URI, metadata, etc.) from the latest block of the blockchain that is indicative of the customization(s) made to corresponding physical collectible(s).

The PBT server 500 is subsequently configured to store the retrieved mint, transfer, and/or customization data in the database server 600. That is, upon identifying that the customization event is recorded on the blockchain, the PBT server 500 is configured to store the customization data associated with the customization event in database(s) of the database server 600. The PBT server 500 is configured to use the URI designated for a respective physical-backed NFT to enable all of associated with the physical-backed NFT to be quickly retrieved for subsequent use.

Upon identifying that a minting event is recorded on the blockchain, the PBT server 500 is configured to store (1) identification data of the corresponding physical-backed NFT 30 in the database(s) of the database server 600 and (2) token data of the corresponding physical-backed NFT 30 in the digital wallet 750 of the collector 110. Upon identifying that a transfer event is recorded on the blockchain, the PBT server 500 is configured to store (1) metadata of the transfer event in the database(s) of the database server 600 and (2) token data of the corresponding physical-backed NFT 30 in the digital wallet 750 of the collector 110. Upon identifying that a customization event is recorded on the blockchain, the PBT server 500 is configured to identify and retrieve the digital customization 45 that corresponds with the customization 25 of the customization event. Subsequently, by modifying the physical-backed NFT 30 with the digital customization 45, the PBT server 500 is configured to create the customized physical-backed NFT 40 that reflects a customized form of the physical collectible 10.

For example, when the customization is a signature on a physical collectible, the customization data retrieved by the PBT server 500 and stored by the database server 600 may include an image of a physical-backed NFT, a photo of the customized physical collectible, an image of a digital modification (e.g., a signature) for the physical-backed NFT, etc. To modify the physical-backed NFT 30 with the digital customization 45 (e.g., a signature), the PBT server 500 is configured to overlay an image of the digital customization 45 (e.g., the signature) onto that of the physical-backed NFT 30. When the customization is a grading score of the current condition of the physical collectible, the customization data retrieved by the PBT server 500 and stored by the database server 600 may include data indicative of an authorized grading scale, authorized grading scores, a grading score assigned to the physical collectible, a photo of the graded physical collectible, etc. Additionally, the customization data may include metadata, such as a timestamp of the customization, identification of the customizer, a location at which the customization occurred, etc.

In the illustrated example, the UI server 300, the blockchain server 400, the PBT server 500, the database server 600 are shown separately. In other examples, two or more of the UI server 300, the blockchain server 400, the PBT server 500, and/or the database server 600 (e.g., the UI server 300 and the PBT server 500) may be combined to form and/or be part of a single server.

Additionally, the PBT system 200 of the illustrated example includes the UI server 300, the blockchain server 400, the PBT server 500, the database server 600, the cache 700, and the digital wallet 750. In other examples, one or more of the above-identified components may be external to and communicate with the PBT system 200. For example, the blockchain server 400, the database server 600, the cache 700, and/or the digital wallet 750 may be external to the PBT system 200 and configured to communicate with the UI server 300 and/or the PBT server 500 of the PBT system 200.

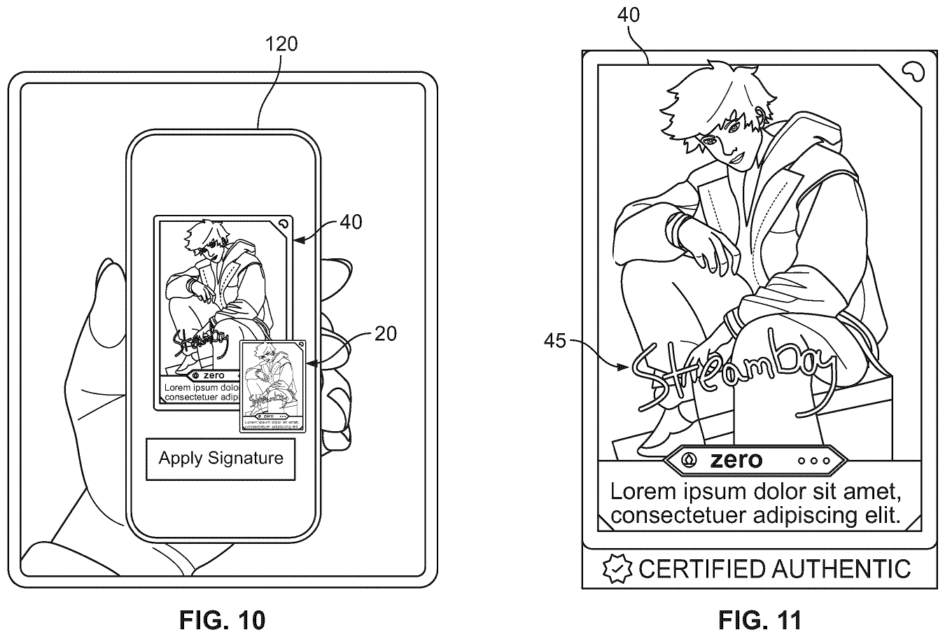

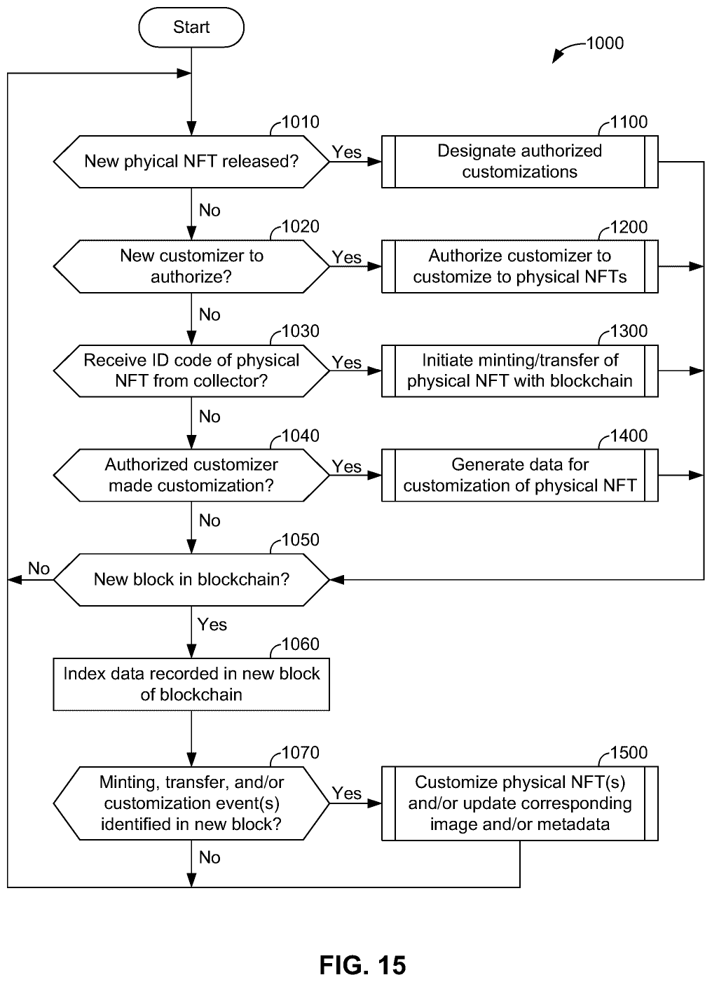

FIG. 15 is a flowchart of an example method 1000 for operating the PBT system 200 to customize physical non-fungible tokens. The flowchart of FIG. 15 is representative of machine readable instructions that are stored in memory (e.g., the memory 820 of FIG. 13, the memory 920 of FIG. 13) and include one or more programs which, when executed by one or more servers (e.g., the UI server 300, the blockchain server 400, and/or the PBT server 500 of FIG. 12) and/or processors (e.g., the processor(s) 810 of FIG. 13, the processor(s) 910 of FIG. 13), to operate the PBT system 200. While the example program is described with reference to the flowchart illustrated in FIG. 15, many other methods may alternatively be used. For example, the order of execution of the blocks may be rearranged, changed, eliminated, and/or combined to perform the method 1000. Further, because the method 1000 is disclosed in connection with the components of FIGS. 1-14, some functions of those components will not be described in detail below.

Initially, at block 1010, the PBT server 500 of the PBT system 200 determines whether any new physical-backed NFTs have been released (e.g., by a creator). For example, the PBT server 500 identifies that new physical-backed NFTs have been released upon receiving corresponding information from creator(s) of the newly released physical-backed NFTs. In response to the PBT server 500 determining that new physical-backed NFT(s) have been released, the method 1000 proceeds to block 1100 at which the PBT server 500 designates authorized customizations to the physical-backed NFT(s).

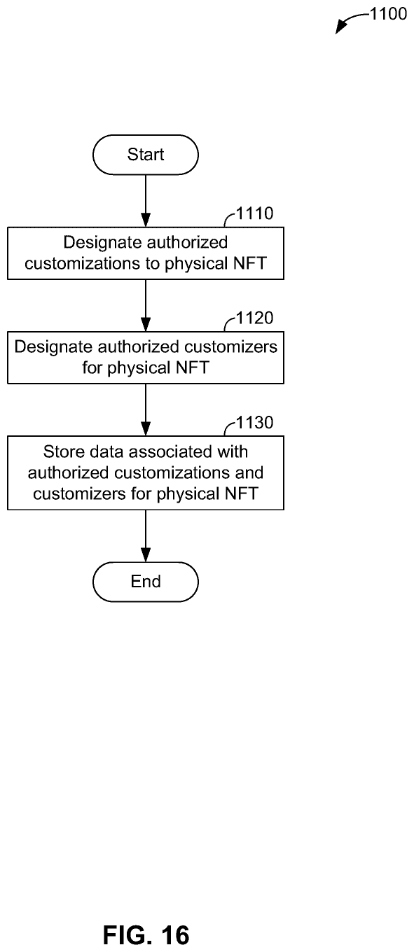

FIG. 16 is a flowchart of an example method 1100 for the PBT server 500 to designate authorized customizations to physical-backed NFTs. The flowchart of FIG. 16 is representative of machine readable instructions that are stored in memory (e.g., the memory 820 of FIG. 13, the memory 920 of FIG. 13) and include one or more programs which, when executed by one or more servers (e.g., the UI server 300, the blockchain server 400, and/or the PBT server 500 of FIG. 12) and/or processors (e.g., the processor(s) 810 of FIG. 13, the processor(s) 910 of FIG. 13), cause the PBT system 200 to designate authorized customizations. While the example program is described with reference to the flowchart illustrated in FIG. 16, many other methods may alternatively be used. For example, the order of execution of the blocks may be rearranged, changed, eliminated, and/or combined to perform the method 1100. Further, because the method 1100 is disclosed in connection with the components of FIGS. 1-14, some functions of those components will not be described in detail below.

The method 1100 is performed, concurrently or sequentially, for each of the released physical-backed NFTs identified at block 1010 of FIG. 15. Turning to block 1110 of FIG. 16, the PBT server 500 designates one or more customizations that are authorized to be made to a physical-backed NFT. Example authorized customizations include a signature, a grading score, etc. The authorized customizations are designed and configured to enable the physical-backed NFT to be customized in a manner that reflects the current condition and/or appearance of a respective physical collectible by matching and/or resembling a customization that has been made to that physical collectible.

At block 1120, the PBT server 500 designates one or more customizers, which have previously been authorized to make customizations to physical-backed NFTs, to make the authorized customization(s) to the newly released physical-backed NFT. Example authorized customizers include an artist associated with the physical-backed NFT, a reputable collectible grader, etc.

At block 1130, the PBT server 500 stores metadata and/or other data associated with the authorized customization(s) and/or customizer(s) for the physical-backed NFT. For example, the PBT server 500 stores the metadata and/or other data associated with the authorized customization(s) and/or customizer(s) in the database server 600. The PBT server 500 stores the data in the database server 600 to facilitate the subsequent generation of customizations to the physical-backed NFT. Upon completion of block 1130, the method 1100 for designating authorized customizations to physical-backed NFTs ends.

Returning to FIG. 15, the method 1000 for operating the PBT system 200 proceeds to block 1050 at which the PBT server 500 determines, as disclosed below in further detail, whether a new block has been created in the blockchain in which the physical-backed NFTs and their customizations are recorded.

Returning to block 1010 of FIG. 15, the method 1000 then proceeds to block 1020 in response to the PBT server 500 determining that no new physical-backed NFT(s) have been released.

At block 1020, the PBT server 500 determines whether any new customizers to authorize for making customizations to the physical-backed NFTs. For example, the PBT server 500 identifies that a new customizer is to be authorized to customize physical-backed NFTs of one or more creators upon receiving corresponding information from those creator(s). For example, the creator of a physical-backed NFT may request that an artist and/or author associated with the physical-backed NFT be allowed to customize it and/or may request that a new collectible grader to be allowed to grade a respective physical collectible. In response to the PBT server 500 determining that new customizer(s) are to be authorized, the method 1000 proceeds to block 1200 at which the PBT server 500 authorizes new customizer(s) to customize the physical-backed NFT(s).

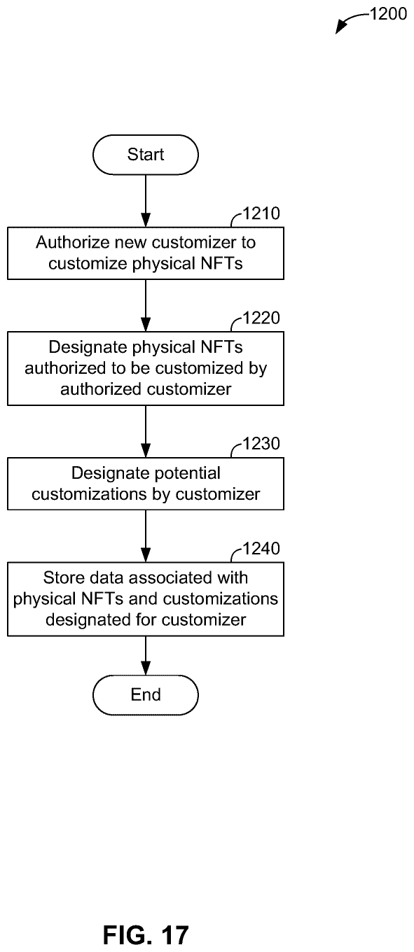

FIG. 17 is a flowchart of an example method 1200 for the PBT server 500 to authorize a customizer to customize physical-backed NFTs. The flowchart of FIG. 17 is representative of machine readable instructions that are stored in memory (e.g., the memory 820 of FIG. 13, the memory 920 of FIG. 13) and include one or more programs which, when executed by one or more servers (e.g., the UI server 300, the blockchain server 400, and/or the PBT server 500 of FIG. 12) and/or processors (e.g., the processor(s) 810 of FIG. 13, the processor(s) 910 of FIG. 13), cause the PBT system 200 to authorize a collectible customizer. While the example program is described with reference to the flowchart illustrated in FIG. 17, many other methods may alternatively be used. For example, the order of execution of the blocks may be rearranged, changed, eliminated, and/or combined to perform the method 1200. Further, because the method 1200 is disclosed in connection with the components of FIGS. 1-14, some functions of those components will not be described in detail below.

The method 1200 is performed, concurrently or sequentially, for each of the new customizers identified at block 1020 of FIG. 15. Turning to block 1210 of FIG. 17, the PBT server 500 authorizes a new customizer to make customizations to physical-backed NFTs. Example authorized customizers include an artist associated with the physical-backed NFT, a reputable collectible grader, etc.

At block 1220, the PBT server 500 designates one or more physical-backed NFTs that the newly authorized customizer is authorized to customize. For example, the PBT server 500 identifies which physical-backed NFT(s) the customizer is authorized to customize based on information collected from the creator(s) of the physical-backed NFT(s).

At block 1230, the PBT server 500 designates one or more customizations that the newly authorized customizer is authorized to use to customize the physical-backed NFT(s) identified at block 1220. That is, the PBT server 500 identifies which physical-backed NFT(s) may be customized by which customizations by the newly authorized customizer. Example authorized customizations that may be made by the authorized customizer include a signature, a grading score, etc. The authorized customizations are designed and configured to enable the physical-backed NFT to be customized in a manner that reflects the current condition and/or appearance of a respective physical collectible by matching and/or resembling a customization that has been made to that physical collectible.

At block 1240, the PBT server 500 stores metadata and/or other data associated with the authorized customizer(s) and/or customization(s) for the physical-backed NFT(s). For example, the PBT server 500 stores the metadata and/or other data associated with the authorized customizer, the physical-backed NFT(s) the customizer is authorized to customize and/or the customization(s) the customizer(s) is authorized to make in the database server 600. The PBT server 500 stores the data in the database server 600 to facilitate the subsequent generation of customizations to the physical-backed NFT. Upon completion of block 1240, the method 1200 for authorizing customizers ends.

Returning to FIG. 15, the method 1000 for operating the PBT system 200 proceeds to block 1050 at which the PBT server 500 determines, as disclosed below in further detail, whether a new block has been created in the blockchain in which the physical-backed NFTs and their customizations are recorded.

Returning to block 1020, the method 1000 then proceeds to block 1030 in response to the PBT server 500 determining that there are no new customizers to authorize.

At block 1030, the UI server 300 of the PBT system 200 determines whether an identification code of a physical-backed NFT has been received from a collector. For example, the collector terminal 310 receives an identification code of a physical-backed NFT upon the collector opening a designated web portal, app, and/or other user interface on their mobile device and positioning the mobile device to wirelessly receive the identification code from the wireless tag of a respective physical collectible. More specifically, the UI server 300 is configured to collect the identification data of a physical-backed NFT from the mobile device of a collector upon (1) the collector possessing the respective physical collectible, (2) the mobile device communicatively pairing to the wireless tag of the physical collectible, (3) the collector opening the PBT user interface on the mobile device, and (4) the mobile device sending the identification data to the collector terminal via wireless communication. In response to the UI server 300 determining that an identification code of a physical-backed NFT has been received from a collector, the method proceeds to block 1300 to initiate a minting or transfer of the physical-backed NFT.

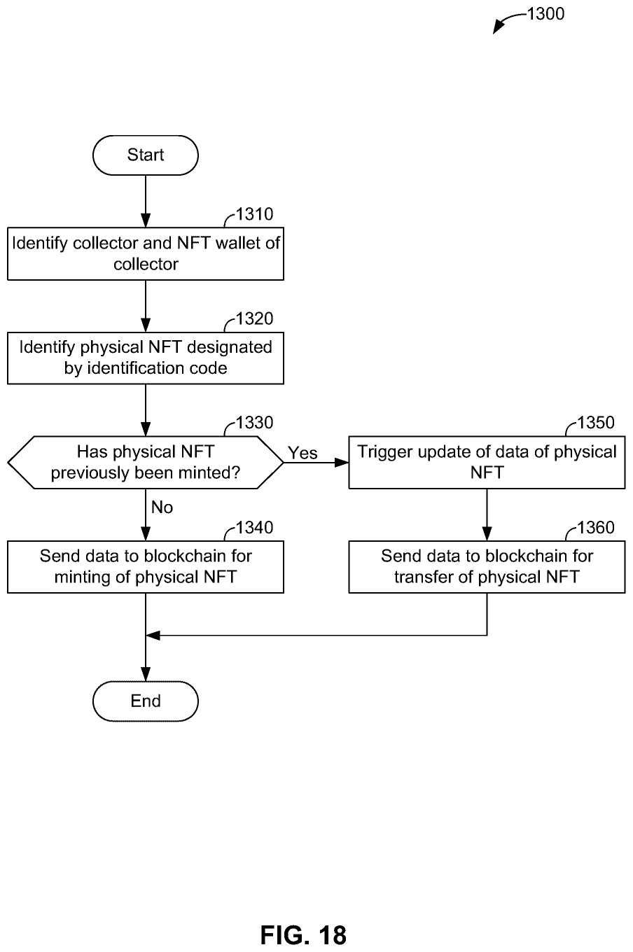

FIG. 18 is a flowchart of an example method 1300 in which the UI server 300, the blockchain server 400, and/or the PBT server 500 initiate the minting or transfer of a physical-backed NFT. The flowchart of FIG. 18 is representative of machine readable instructions that are stored in memory (e.g., the memory 820 of FIG. 13, the memory 920 of FIG. 13) and include one or more programs which, when executed by one or more servers (e.g., the UI server 300, the blockchain server 400, and/or the PBT server 500 of FIG. 12) and/or processors (e.g., the processor(s) 810 of FIG. 13, the processor(s) 910 of FIG. 13), cause the PBT system 200 to have a physical-backed NFT minted and/or transferred. While the example program is described with reference to the flowchart illustrated in FIG. 18, many other methods may alternatively be used. For example, the order of execution of the blocks may be rearranged, changed, eliminated, and/or combined to perform the method 1300. Further, because the method 1300 is disclosed in connection with the components of FIGS. 1-14, some functions of those components will not be described in detail below.

Initially, at block 1310, the UI server 300 identifies the collector from which the UI server 300 received the identification code for the physical-backed NFT. For example, the collector terminal 310 of the UI server 300 identifies the collector based on identifying information of the collector (e.g., due to the collector signing into a PBT app or web portal) and/or the mobile device of the collector from which the identification code is received. Additionally, the UI server 300 identifies the digital wallet of the collector. At block 1320, the UI server 300 identifies the physical-backed NFT that is designated to correspond with the identification code that was collected by the mobile device of the collector from the wireless tag of the respective physical collectible.

At block 1330, the UI server 300, the blockchain server 400, and/or the PBT server 500 determines whether the physical-backed NFT that corresponds with the received identification code has previously been minted. For example, to determine whether the physical-backed NFT has already been minted, the UI server 300, the blockchain server 400, and/or the PBT server 500 checks recordings of the blockchain to identify whether a minting of the physical-backed NFT has already been recorded on the blockchain.

In response to the UI server 300, the blockchain server 400, and/or the PBT server 500 determining that the physical-backed NFT associated with the received identification code has yet to be minted, the method 1300 proceeds to block 1340.

At block 1340, the UI server 300 sends data associated with the physical-backed NFT, the physical collectible, and/or the collector to the collector smart contract 410 of the blockchain server 400 to cause the blockchain server 400 to mint the physical-backed NFT and record minting of the physical-backed NFT in the most recent block of the blockchain. For example, the UI server 300 sends the identification code, a private key, metadata, and/or other data associated with the physical-backed NFT, the physical collectible, and/or the collector (e.g., a private key) to the collector smart contract 410 to initiate minting of the physical-backed NFT. Upon completion of block 1340, the method 1300 ends.

Returning to block 1330, the method 1300 then proceeds to block 1350 in response to the UI server 300, the blockchain server 400, and/or the PBT server 500 determining that the physical-backed NFT associated with the received identification code has previously been minted. At block 1350, the UI server 300 triggers an update of the metadata and/or other data associated with the physical-backed NFT and/or the transfer of the physical-backed NFT. For example, the UI server 300 sends metadata and/or other data associated with the physical-backed NFT to the PBT server 500, and the PBT server 500 subsequently stores that data in the database server 600.

At block 1340, the UI server 300 sends data associated with the physical-backed NFT, the physical collectible, and/or the collector to the collector smart contract 410 of the blockchain server 400 to cause the blockchain server 400 to record, on the blockchain, the transfer of the physical-backed NFT to the collector currently in possession of the respective physical collectible designated with the physical-backed NFT. For example, the UI server 300 sends the identification code, a private key, metadata, and/or other data associated with the physical-backed NFT, the physical collectible, and/or the collector (e.g., a private key) to the collector smart contract 410 to initiate the transfer of the physical-backed NFT on the blockchain. Upon completion of block 1340, the method 1300 ends.

That is, upon completion of block 1340 or block 1360, the method 1300 for minting and/or transferring the physical-backed NFT ends. Returning to FIG. 15, the method 1000 for operating the PBT system 200 proceeds to block 1050 at which the PBT server 500 determines, as disclosed below in further detail, whether a new block has been created in the blockchain in which the physical-backed NFTs and their customizations are recorded.

Returning to block 1030, the method 1000 then proceeds to block 1040 in response to the UI server 300 of the PBT system 200 determining that an identification code of a physical-backed NFT has not been received from a collector.

At block 1040, the UI server 300 determines whether an authorized customizer has made a customization to a physical collectible. For example, the customizer terminal 320 of the UI server 300 is configured to collect information from a customizer via a web portal, app, and/or another user interface for PBTs that is operating on the mobile device of the customizer. For example, the UI server 300 collects customization data (e.g., an image of a signature, a grading score, etc.) that is indicative of a customization to a physical collectible and is subsequently used to customize a respective physical-backed NFT. The UI server 300 may identify that a customization has occurred upon collecting an image and/or a video of the customized physical collectible that has been captured by a camera of the mobile device and uploaded via a web portal, app, and/or other user interface for PBTs. The UI server 300 may also identify that a customization has occurred by collecting other data, including metadata (e.g., a timestamp, a location, etc.), that is indicative of an occurrence of a customization event.

In response to the UI server 300 determining that an authorized customizer has not made a customization to a physical collectible, the method 1000 proceeds to block 1050 at which the PBT server 500 determines, as disclosed below in further detail, whether a new block has been created in the blockchain in which the physical-backed NFTs and their customizations are recorded. Otherwise, in response to the UI server 300 determining at block 1040 that an authorized customizer has made a customization to a physical collectible, the method 1000 proceeds block 1400 at which the UI server 300 and/or the PBT server 500 generates and stores image, meta-, and/or other data for the customization of a respective physical-backed NFT.

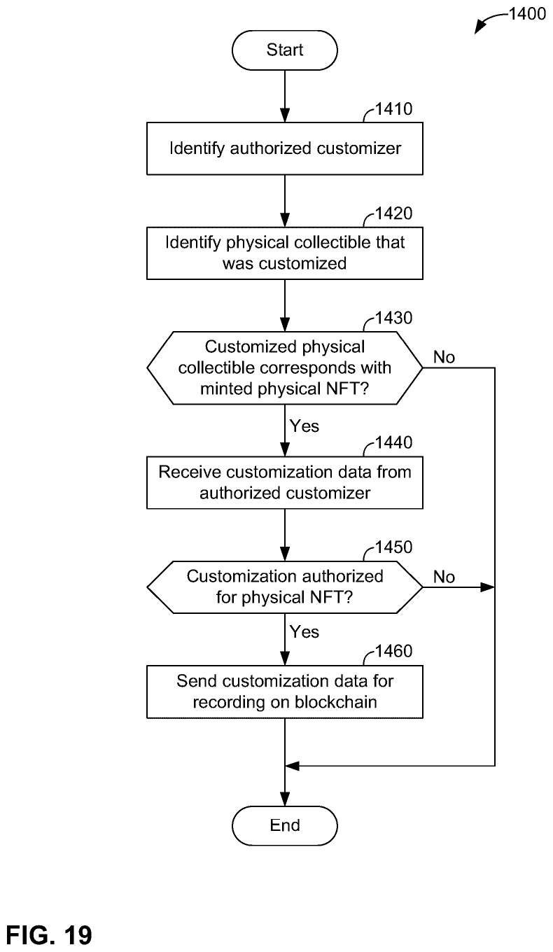

FIG. 19 is a flowchart of an example method 1400 in which the UI server 300 and/or the PBT server generate image data, metadata, and/or other data for a customization of a physical-backed NFT. The flowchart of FIG. 19 is representative of machine readable instructions that are stored in memory (e.g., the memory 820 of FIG. 13, the memory 920 of FIG. 13) and include one or more programs which, when executed by one or more servers (e.g., the UI server 300, the blockchain server 400, and/or the PBT server 500 of FIG. 12) and/or processors (e.g., the processor(s) 810 of FIG. 13, the processor(s) 910 of FIG. 13), cause the PBT system 200 to have generate customization data of a physical-backed NFT. While the example program is described with reference to the flowchart illustrated in FIG. 19, many other methods may alternatively be used. For example, the order of execution of the blocks may be rearranged, changed, eliminated, and/or combined to perform the method 1400. Further, because the method 1400 is disclosed in connection with the components of FIGS. 1-14, some functions of those components will not be described in detail below.

The method 1400 is performed, concurrently or sequentially, for each customization recently identified as having been made by the customizer at block 1040 of FIG. 15. Turning to block 1410 of FIG. 19, the UI server 300 identifies the authorized customizer that has made the customization to the physical collectible. For example, the customizer terminal 320 of the UI server 300 identifies the customizer based on identifying information of the customizer (e.g., due to the customizer signing into a PBT app or web portal) and/or the mobile device of the customizer from which information indicative of the customization was received.

At block 1420, the customizer terminal 320 of the UI server 300 identifies the physical collectible that has been customized by the authorized customizer. For example, the UI server 300 identifies which physical collectible has been customized by (1) collecting information obtained by pairing the mobile device of the customizer to the wireless tag of the physical collectible and/or (2) collecting image(s) and/or video of the physical collectible that was captured via the camera of the mobile device.

At block 1430, the PBT server 500 determines whether the physical collectible that has been customized by the authorized customizer corresponds with a physical-backed NFT that has been minted. For example, the PBT server 500 compares identification data of the physical collectible to identification data stored by the database server 600 for minted physical-backed NFTs. In response to the PBT server 500 determining that the customized physical collectible does not correspond with a minted physical-backed NFT, the method 1400 ends. Otherwise, in response to the PBT server 500 determining that the customized physical collectible does correspond with a minted physical-backed NFT, the method 1400 proceeds to block 1440.

At block 1440, the customizer terminal 320 of the UI server 300 receives customization data associated with the customized physical collectible from the authorized customizer. For example, the UI server 300 collects image(s) and/or video of the customization that was captured via the camera of the mobile device of the customizer. Additionally or alternatively, the customizer may provide other customization data (e.g., a grading score; a corresponding grading scale; metadata such as a date, time, and location at which the customization occurred) by uploading the customization data via the app and/or web portal operating on the mobile device of the customizer.

At block 1450, the PBT server 500 determines whether the corresponding customization to the respective physical-backed NFT is authorized and whether the customizer is authorized to make that customization. For example, the PBT server 500 determines whether such a customization is authorized based on the customization and customizer authorization data stored by the database server 600. In response to the PBT server 500 determining that the customizer of the physical collectible is not authorized for a related customization to the respective physical-backed NFT, the method 1400 ends. Otherwise, in response to the PBT server 500 determining that the customizer of the physical collectible is authorized for a related customization to the respective physical-backed NFT, the method 1400 proceeds to block 1460 at which the PBT server 500 sends the customization data related to the physical collectible and/or the respective physical-backed NFT to the customizer smart contract 420 of the blockchain server 400 to initiate the recording of the customization of the physical collectible and/or the physical-backed NFT on the blockchain. The method 1400 ends upon completion of block 1460.

That is, upon (1) completion of block 1460, (2) the PBT server 500 determining at block 1430 that the customized physical collectible does not correspond with a minted physical-back NFT that is authorized to be customized, or (3) the PBT server 500 determining at block 1450 that the corresponding customization is not authorized for the physical-back NFT, the method 1400 for generating customization data of a physical-backed NFT ends. Returning to FIG. 15, the method 1000 for operating the PBT system 200 proceeds to block 1050 (1) in response to completing blocks 1100, 1200, 1300, or 1400 or (2) in response the UI server 300 determining at block 1040 that no authorized customizer has made a recent customization.

At block 1050, the PBT server 500 and/or the blockchain server 400 determines whether there is a new block in the blockchain. For example, the PBT server 500 and/or the blockchain server 400 indexes the blockchain to identify the most recent block in the blockchain. The PBT server 500 and/or the blockchain server 400 also indexes the cache 700 to identify the most recent block in the blockchain that has been processed by the PBT server 500 and/or the blockchain server 400 for identification of recent mintings, transfers, and/or customizations. That is, the cache 700 stores data identifying the last block in the blockchain that has been reviewed by the PBT system 200. The PBT server 500 and/or the blockchain server 400 determines that there is not a new block in the blockchain in response to identifying that the last block identified in the cache 700 matches the most recent block in the blockchain. In contrast, the PBT server 500 and/or the blockchain server 400 determines that there is a new block in the blockchain in response to identifying that the last block identified in the cache 700 does not match the most recent block in the blockchain.

In response to the PBT server 500 and/or the blockchain server 400 determining that there is not a new block in the blockchain, the method 1000 returns to block 1010. Otherwise, in response to the PBT server 500 and/or the blockchain server 400 determining that there is a new block in the blockchain, the method 1000 proceeds to block 1060.

At block 1060, the PBT server 500 and/or the blockchain server 400 indexes the new block in the blockchain for the data recorded in the new block. At block 1070, the PBT server 500 and/or the blockchain server 400 determines whether the data recorded in the new block identifies any new minting, transfer, and/or customization event(s) for physical-backed NFT(s). In response to the PBT server 500 and/or the blockchain server 400 determining that the new block in the blockchain does not include any recorded data indicative of a minting, transfer, and/or customization of physical-backed NFT(s), the method 1000 returns to block 1000. Otherwise, in response to the PBT server 500 and/or the blockchain server 400 determining that the new block in the blockchain does include recorded data indicative of a minting, transfer, and/or customization of physical-backed NFT(s), the method proceeds to block 1500 at which the PBT server 500 customizes physical-backed NFT(s) and/or updates image, meta-, and/or other data corresponding with a minting, transfer, and/or customization of physical-backed NFT(s).

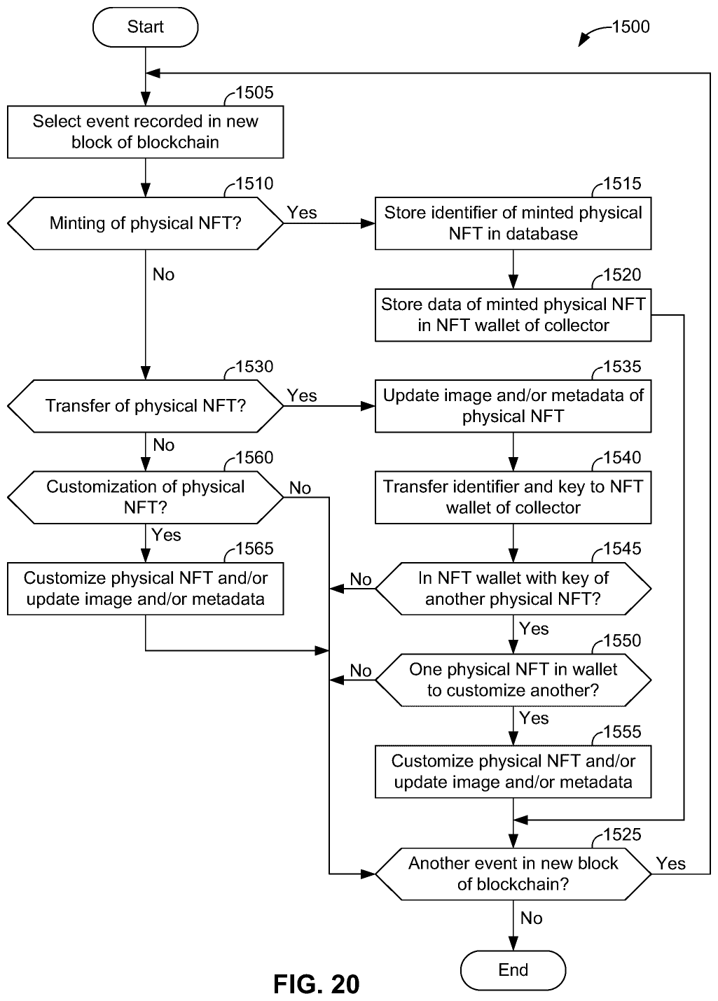

FIG. 20 is a flowchart of an example method 1400 for the PBT server 500 and/or the blockchain server 400 to create a customization of and/or update corresponding customization data for a physical-backed NFT. The flowchart of FIG. 20 is representative of machine readable instructions that are stored in memory (e.g., the memory 820 of FIG. 13, the memory 920 of FIG. 13) and include one or more programs which, when executed by one or more servers (e.g., the UI server 300, the blockchain server 400, and/or the PBT server 500 of FIG. 12) and/or processors (e.g., the processor(s) 810 of FIG. 13, the processor(s) 910 of FIG. 13), cause the PBT system 200 to create a customization of and/or update corresponding customization data for a physical-backed NFT. While the example program is described with reference to the flowchart illustrated in FIG. 20, many other methods may alternatively be used. For example, the order of execution of the blocks may be rearranged, changed, eliminated, and/or combined to perform the method 1500. Further, because the method 1500 is disclosed in connection with the components of FIGS. 1-14, some functions of those components will not be described in detail below.

Initially, at block 1505, the blockchain server 400 and/or the PBT server 500 selects an event recorded in the new block of the blockchain. At block 1510, the blockchain server 400 and/or the PBT server 500 determines whether the selected event is a minting event of a physical-backed NFT.

In response to the blockchain server 400 and/or the PBT server 500 determining that the selected event is a minting event, the method 1500 proceeds to block 1515 at which the database server 600 obtains the recorded data for the minting and stores data of the minted physical-backed NFT for subsequent retrieval when presenting the physical-backed NFT to the corresponding collector. Example data stored by the database server 600 for the minted physical-backed NFT includes an identification code (e.g., a URI), an image of the physical-backed NFT, metadata of the minting of the physical-backed NFT, authorized customizations, authorized customizers, etc. At block 1520, the PBT server 500 stores data associated with the minted physical-backed NFT in the digital wallet 750 of the collector to facilitate the collector in securely storing and accessing the physical-backed NFT. Upon completion of block 1520, the method 1500 proceeds to block 1525.

At block 1525, the blockchain server 400 and/or the PBT server 500 determines whether there is another event in the new block of the blockchain to review. In response to the blockchain server 400 and/or the PBT server 500 determining that there is another event in the new block of the blockchain to review, the method 1500 returns to block 1505. Otherwise, in response to the blockchain server 400 and/or the PBT server 500 determining that there is no other event in the new block of the blockchain to review, the method 1500 ends.

Returning to block 1510, the method 1500 then proceeds to block 1530 in response to the blockchain server 400 and/or the PBT server 500 determining that the selected event is not a minting event. At block 1530, the blockchain server 400 and/or the PBT server 500 determines whether the selected event is a transfer event of a physical-backed NFT.

In response to the blockchain server 400 and/or the PBT server 500 determining that the selected event is a transfer event, the method 1500 proceeds to block 1535 at which the database server 600 obtains the recorded data for the transfer of the physical-backed NFT (e.g., image, meta-, and/or other data) and stores that data for subsequent retrieval when presenting the physical-backed NFT to the corresponding collector. Example data stored by the database server 600 for the transferred physical-backed NFT includes the identification code, an image of the physical-backed NFT, metadata of the minting and/or transfer of the physical-backed NFT, authorized customizations, authorized customizers, etc. At block 1540, the PBT server 500 transfers the key and/or other data of the physical-backed NFT from the digital wallet of the collector in previous possession of the physical-backed NFT to the digital wallet of the collector currently in possession of the physical-backed NFT.

At block 1545, the PBT server 500 determines whether the recently transferred physical-backed NFT is now stored in a digital wallet with another physical-backed NFT. In response to the PBT server 500 determining that the recently transferred physical-backed NFT is not stored in a digital wallet with another physical-backed NFT, the method 1500 proceeds to block 1525. Otherwise, in response to the PBT server 500 determining that the recently transferred physical-backed NFT is stored in a digital wallet with another physical-backed NFT, the method 1500 proceeds to block 1550.

At block 1550, the PBT server 500 determines whether the recently transferred physical-backed NFT customizes and/or is customized by the other physical-backed NFT stored in the same digital wallet. For example, the appearance of recently transferred physical-backed NFT may customize the appearance of the other physical-backed NFT or vice versa (e.g., a physical-backed NFT with an image of a baseball player is customized with a team jersey shown in the image of another physical-backed NFT). The PBT server 500 may determine whether one physical-backed NFT customizes and/or is customized by another physical-backed NFT based on customization data stored by the database server 600.

In response to the PBT server 500 determining that the recently transferred physical-backed NFT does not customize and/or is not customized by another physical-backed NFT stored in the same digital wallet, the method 1500 proceeds to block 1525. Otherwise, in response to the PBT server 500 determining that the recently-transferred physical-backed NFT customizes and/or is customized by another physical-backed NFT stored in the same digital wallet, the method 1500 proceeds to block 1555 at which the PBT server 500 customizes the recently-transferred physical-backed NFT and/or the other physical-backed NFT stored in the same digital wallet. Additionally, the PBT server 500 updates the image, meta-, and/or other data associated with the recently transferred physical-backed NFT and/or the other physical-backed NFT to reflect the customization in the database server 600 and/or the digital wallet of the collector. Upon completion of block 1555, the method 1500 proceeds to block 1525.

Returning to block 1530, the method 1500 then proceeds to block 1560 in response to the blockchain server 400 and/or the PBT server 500 determining that the selected event is not a transfer event. At block 1560, the blockchain server 400 and/or the PBT server 500 determines whether the selected event is a customization event of a physical-backed NFT. In response to the blockchain server 400 and/or the PBT server 500 determining that the selected event is not a customization event, the method 1500 proceeds to block 1525. Otherwise, in response to the blockchain server 400 and/or the PBT server 500 determining that the selected event is a customization event, the method 1500 proceeds to block 1565.

At block 1565, the PBT server 500 customizes the physical-backed NFT to reflect the customization of the respective physical collectible. The PBT server 500 customizes the physical-backed NFT with a digital customization to match, resemble and/or reflect the customization made by the authorized customizer to the respective physical collectible so that customized physical-backed NFT is reflective of the current physical state and/or appearance of the customized physical collectible. Additionally, the PBT server 500 updates the image, meta-, and/or other data associated with the customized physical-backed NFT in the database server 600 and/or the digital wallet of the collector. Upon completion of block 1565, the method proceeds to block 1525.

Again, the method 1500 ends in response to the blockchain server 400 and/or the PBT server 500 determining at block 1525 that there is no other event in the new block of the blockchain to review. Returning to FIG. 15, the method 1000 for operating the PBT system 200 subsequently returns to block 1010 upon completion of block 1500.

Exemplary embodiments in accordance with the teachings herein are disclosed below.

Embodiment 1. A system is for customizing physical-backed non-fungible tokens. The system includes one or more databases configured to store image data indicative of a physical-backed non-fungible token. The physical-backed non-fungible token is a non-fungible token designated with a physical collectible. The image data includes data for a digital customization that reflects a customization made to the physical collectible The system includes one or more servers. The one or more servers is configured to receive, via a first mobile device of a collector, an identification code stored in a wireless tag of the physical collectible. The identification code is designated for both the physical collectible and the physical-backed non-fungible token. The one or more servers is configured to send the identification code to a collector smart contract to record a minting or transfer of the physical-backed non-fungible token on a blockchain; receive, via a second mobile device of an authorized customizer, customization data indicative of the customization made to the physical collectible by the authorized customizer during a customization event; send the customization data to a customizer smart contract to record the customization on the blockchain; and retrieve recorded data from the blockchain. Upon identifying that the customization event is recorded on the blockchain, the one or more servers is configured to store, in the one or more databases, the customization data that is associated with the customization event and included in the recorded data; identify and retrieve the digital customization that corresponds with the customization of the customization data retrieved from the blockchain; and create a customized physical-backed non-fungible token that reflects a customized form of the physical collectible by modifying the physical-backed non-fungible token with the digital customization.

Embodiment 2. The system of Embodiment 1, wherein the one or more servers is configured to provide an image of the customized physical-backed non-fungible token for presentation to the collector via the first mobile device.

Embodiment 3. The system of Embodiment 1 or 2, wherein to modify the physical-backed non-fungible token with the digital customization to create the customized physical-backed non-fungible token, the one or more servers is configured to overlay an image of the digital customization onto that of the physical-backed non-fungible token.

Embodiment 4. The system of any of Embodiments 1-3, wherein the one or more servers is configured to receive the identification code via wireless communication with the first mobile device of the collector upon the first mobile device receiving the identification code via wireless communication with the wireless tag of the physical collectible.

Embodiment 5. The system of any of Embodiments 1-4, wherein, to retrieve the recorded data from the blockchain, the one or more servers is configured to index the blockchain to identify a most recent block in the blockchain; index cache to identify whether the most recent block in the blockchain has already been indexed; and, in response to determining that the most recent block has yet to be indexed, retrieve the recorded data from the most recent block in the blockchain.

Embodiment 6. The system of any of Embodiments 1-5, wherein, upon identifying that a minting event is recorded on the blockchain, the one or more servers is configured to store identification data of the non-fungible token that was minted in the one or more databases and token data of the non-fungible token that was minted in a digital wallet of the collector.

Embodiment 7. The system of any of Embodiments 1-6, wherein, upon identifying that a transfer event is recorded on the blockchain, the one or more servers is configured to store metadata of the transfer event in the one or more databases and token data of the non-fungible token that was transferred in a digital wallet of the collector.

Embodiment 8. A method is for customizing physical-backed non-fungible tokens. The method includes storing, in one or more databases, image data indicative of a physical-backed non-fungible token. The physical-backed non-fungible token is a non-fungible token designated with a physical collectible. The image data includes data for a digital customization that reflects a customization made to the physical collectible. The method includes receiving, via one or more servers, an identification code stored in a wireless tag of the physical collectible from a first mobile device of a collector. The identification code is designated for both the physical collectible and the physical-backed non-fungible token. The method includes sending, via the one or more servers, the identification code to a collector smart contract to record a minting or transfer of the physical-backed non-fungible token on a blockchain and receiving, via the one or more servers, customization data from a second mobile device of an authorized customizer. The customization data is indicative of the customization made to the physical collectible by the authorized customizer during a customization event. The method includes sending, via the one or more servers, the customization data to a customizer smart contract to record the customization on the blockchain and retrieving, via the one or more servers, recorded data from the blockchain. The method, upon identifying that the customization event is recorded on the blockchain, includes storing, in the one or more databases, the customization data that is associated with the customization event and included in the recorded data; identifying and retrieving, via the one or more servers, the digital customization that corresponds with the customization of the customization data retrieved from the blockchain; and creating, via the one or more servers, a customized physical-backed non-fungible token that reflects a customized form of the physical collectible by modifying the physical-backed non-fungible token with the digital customization.

Embodiment 9. The method of Embodiment 8, further including providing, via the one or more servers, an image of the customized physical-backed non-fungible token for presentation to the collector via the first mobile device.

Embodiment 10. The method of Embodiment 8 or 9, wherein modifying the physical-backed non-fungible token with the digital customization to create the customized physical-backed non-fungible token includes overlaying, via the one or more servers, an image of the digital customization onto that of the physical-backed non-fungible token.

Embodiment 11. The method of any of Embodiments 8-10, wherein receiving the identification code includes wirelessly communicating the identification code from the wireless tag of the physical collectible to the first mobile device of the consumer and wirelessly communicating the identification code from the first mobile device of the consumer to the one or more servers.

Embodiment 12. The method of any of Embodiments 8-11, wherein retrieving the recorded data from the blockchain includes indexing, via the one or more servers, the blockchain to identify a most recent block in the blockchain; indexing, via the one or more servers, cache to identify whether the most recent block in the blockchain has already been indexed; and, in response to determining that the most recent block has yet to be indexed, retrieving, via the one or more servers, the recorded data from the most recent block in the blockchain.

Embodiment 13. The method of any of Embodiments 8-12, further including, upon identifying that a minting event is recorded on the blockchain, storing identification data of the non-fungible token that was minted in the one or more databases and storing token data of the non-fungible token that was minted in a digital wallet of the collector.

Embodiment 14. The method of any of Embodiments 8-13, further including, upon identifying that a transfer event is recorded on the blockchain, storing metadata of the transfer event in the one or more databases and storing token data of the non-fungible token that was transferred in a digital wallet of the collector.

Embodiment 15. Computer readable media includes instructions, which, when executed, cause one or more machines to collectively store image data indicative of a physical-backed non-fungible token. The physical-backed non-fungible token is a non-fungible token designated with a physical collectible. The image data includes data for a digital customization that reflects a customization made to the physical collectible. The instructions, when executed, cause the one or more machines to collectively receive an identification code stored in a wireless tag of the physical collectible from a first mobile device of a collector. The identification code is designated for both the physical collectible and the physical-backed non-fungible token. The instructions, when executed, cause the one or more machines to collectively send the identification code to a collector smart contract to record a minting or transfer of the physical-backed non-fungible token on a blockchain and receive customization data from a second mobile device of an authorized customizer. The customization data is indicative of the customization made to the physical collectible by the authorized customizer during a customization event. The instructions, when executed, cause the one or more machines to collectively send the customization data to a customizer smart contract to record the customization on the blockchain and retrieve recorded data from the blockchain. The instructions, when executed, cause the one or more machines, upon identifying that the customization event is recorded on the blockchain, to collectively store the customization data that is associated with the customization event and included in the recorded data; identify and retrieve the digital customization that corresponds with the customization of the customization data retrieved from the blockchain; and create a customized physical-backed non-fungible token that reflects a customized form of the physical collectible by modifying the physical-backed non-fungible token with the digital customization.

Embodiment 16. The computer readable media of Embodiment 15, wherein the instructions, when executed, further cause the one or more machines to collectively provide an image of the customized physical-backed non-fungible token for presentation to the collector via the first mobile device.

Embodiment 17. The computer readable media of Embodiment 15 or 16, wherein, to modify the physical-backed non-fungible token with the digital customization to create the customized physical-backed non-fungible token, the instructions, when executed, further cause the one or more machines to collectively overlay an image of the digital customization onto that of the physical-backed non-fungible token.

Embodiment 18. The computer readable media of any of Embodiments 15-17, wherein, to receive the identification code, the instructions, when executed, further cause the one or more machines to collectively receive the identification code via wireless communication with the first mobile device of the collector upon the first mobile device receiving the identification code via wireless communication with the wireless tag of the physical collectible.

Embodiment 19. The computer readable media of any of Embodiments 15-18, wherein, to retrieve the recorded data from the blockchain, the instructions, when executed, further cause the one or more machines to collectively index the blockchain to identify a most recent block in the blockchain; index cache to identify whether the most recent block in the blockchain has already been indexed; and retrieve the recorded data from the most recent block in the blockchain in response to determining that the most recent block has yet to be indexed.

Embodiment 20. The computer readable media of any of Embodiments 15-19, wherein the instructions, when executed, further cause the one or more machines, upon identifying that a minting event is recorded on the blockchain, to collectively store identification data of the non-fungible token that was minted and store token data of the non-fungible token that was minted in a digital wallet of the collector.

Embodiment 21. The computer readable media of any of Embodiments 15-20, wherein the instructions, when executed, further cause the one or more machines, upon identifying that a transfer event is recorded on the blockchain, to collectively store metadata of the transfer event and store token data of the non-fungible token that was transferred in a digital wallet of the collector.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A system for customizing physical-backed non-fungible tokens, the system comprising:
one or more databases configured to store image data indicative of a physical-backed non-fungible token, wherein the physical-backed non-fungible token is a non-fungible token designated with a physical collectible, wherein the image data includes data for a digital customization that reflects a customization made to the physical collectible; and
one or more servers configured to:
receive, via a first mobile device of a collector, an identification code stored in a wireless tag of the physical collectible, wherein the identification code is designated for both the physical collectible and the physical-backed non-fungible token;
send the identification code to a collector smart contract to record a minting or transfer of the physical-backed non-fungible token on a blockchain;
receive, via a second mobile device of an authorized customizer, customization data indicative of the customization made to the physical collectible by the authorized customizer during a customization event;
send the customization data to a customizer smart contract to record the customization on the blockchain;
retrieve recorded data from the blockchain; and
upon identifying that the customization event is recorded on the blockchain:
store, in the one or more databases, the customization data that is associated with the customization event and included in the recorded data;
identify and retrieve the digital customization that corresponds with the customization of the customization data retrieved from the blockchain; and
create a customized physical-backed non-fungible token that reflects a customized form of the physical collectible by modifying the physical-backed non-fungible token with the digital customization.

2. The system of claim 1, wherein the one or more servers is configured to provide an image of the customized physical-backed non-fungible token for presentation to the collector via the first mobile device.

3. The system of claim 1, wherein, to modify the physical-backed non-fungible token with the digital customization to create the customized physical-backed non-fungible token, the one or more servers is configured to overlay an image of the digital customization onto that of the physical-backed non-fungible token.

4. The system of claim 1, wherein the one or more servers is configured to receive the identification code via wireless communication with the first mobile device of the collector upon the first mobile device receiving the identification code via wireless communication with the wireless tag of the physical collectible.

5. The system of claim 1, wherein, to retrieve the recorded data from the blockchain, the one or more servers is configured to:
index the blockchain to identify a most recent block in the blockchain;
index cache to identify whether the most recent block in the blockchain has already been indexed; and
in response to determining that the most recent block has yet to be indexed, retrieve the recorded data from the most recent block in the blockchain.

6. The system of claim 1, wherein, upon identifying that a minting event is recorded on the blockchain, the one or more servers is configured to store:
identification data of the non-fungible token that was minted in the one or more databases; and
token data of the non-fungible token that was minted in a digital wallet of the collector.

7. The system of claim 1, wherein, upon identifying that a transfer event is recorded on the blockchain, the one or more servers is configured to store:
metadata of the transfer event in the one or more databases; and
token data of the non-fungible token that was transferred in a digital wallet of the collector.

8. A method for customizing physical-backed non-fungible tokens, the method comprising:
storing, in one or more databases, image data indicative of a physical-backed non-fungible token, wherein the physical-backed non-fungible token is a non-fungible token designated with a physical collectible, wherein the image data includes data for a digital customization that reflects a customization made to the physical collectible;
receiving, via one or more servers, an identification code stored in a wireless tag of the physical collectible from a first mobile device of a collector, wherein the identification code is designated for both the physical collectible and the physical-backed non-fungible token;
sending, via the one or more servers, the identification code to a collector smart contract to record a minting or transfer of the physical-backed non-fungible token on a blockchain;
receiving, via the one or more servers, customization data from a second mobile device of an authorized customizer, wherein the customization data is indicative of the customization made to the physical collectible by the authorized customizer during a customization event;
sending, via the one or more servers, the customization data to a customizer smart contract to record the customization on the blockchain; and
retrieving, via the one or more servers, recorded data from the blockchain; and
upon identifying that the customization event is recorded on the blockchain:
storing, in the one or more databases, the customization data that is associated with the customization event and included in the recorded data;
identifying and retrieving, via the one or more servers, the digital customization that corresponds with the customization of the customization data retrieved from the blockchain; and
creating, via the one or more servers, a customized physical-backed non-fungible token that reflects a customized form of the physical collectible by modifying the physical-backed non-fungible token with the digital customization.

9. The method of claim 8, wherein modifying the physical-backed non-fungible token with the digital customization to create the customized physical-backed non-fungible token includes overlaying, via the one or more servers, an image of the digital customization onto that of the physical-backed non-fungible token.

10. The method of claim 8, wherein receiving the identification code comprises:
wirelessly communicating the identification code from the wireless tag of the physical collectible to the first mobile device of the collector; and
wirelessly communicating the identification code from the first mobile device of the collector to the one or more servers.

11. The method of claim 8, wherein retrieving the recorded data from the blockchain comprises:
indexing, via the one or more servers, the blockchain to identify a most recent block in the blockchain;
indexing, via the one or more servers, cache to identify whether the most recent block in the blockchain has already been indexed; and
in response to determining that the most recent block has yet to be indexed, retrieving, via the one or more servers, the recorded data from the most recent block in the blockchain.

12. The method of claim 8, further comprising, upon identifying that a minting event is recorded on the blockchain:
storing identification data of the non-fungible token that was minted in the one or more databases; and
storing token data of the non-fungible token that was minted in a digital wallet of the collector.

13. The method of claim 8, further comprising, upon identifying that a transfer event is recorded on the blockchain:
storing metadata of the transfer event in the one or more databases; and
storing token data of the non-fungible token that was transferred in a digital wallet of the collector.

14. Computer readable media comprising instructions, which, when executed, cause one or more machines to collectively:
store image data indicative of a physical-backed non-fungible token, wherein the physical-backed non-fungible token is a non-fungible token designated with a physical collectible, wherein the image data includes data for a digital customization that reflects a customization made to the physical collectible;
receive an identification code stored in a wireless tag of the physical collectible from a first mobile device of a collector, wherein the identification code is designated for both the physical collectible and the physical-backed non-fungible token;
send the identification code to a collector smart contract to record a minting or transfer of the physical-backed non-fungible token on a blockchain;
receive customization data from a second mobile device of an authorized customizer, wherein the customization data is indicative of the customization made to the physical collectible by the authorized customizer during a customization event;
send the customization data to a customizer smart contract to record the customization on the blockchain; and
retrieve recorded data from the blockchain; and
upon identifying that the customization event is recorded on the blockchain:
store the customization data that is associated with the customization event and included in the recorded data;
identify and retrieve the digital customization that corresponds with the customization of the customization data retrieved from the blockchain; and
create a customized physical-backed non-fungible token that reflects a customized form of the physical collectible by modifying the physical-backed non-fungible token with the digital customization.

15. The computer readable media of claim 14, wherein the instructions, when executed, further cause the one or more machines to collectively provide an image of the customized physical-backed non-fungible token for presentation to the collector via the first mobile device.

16. The computer readable media of claim 14, wherein, to modify the physical-backed non-fungible token with the digital customization to create the customized physical-backed non-fungible token, the instructions, when executed, further cause the one or more machines to collectively overlay an image of the digital customization onto that of the physical-backed non-fungible token.

17. The computer readable media of claim 14, wherein, to receive the identification code, the instructions, when executed, further cause the one or more machines to collectively receive the identification code via wireless communication with the first mobile device of the collector upon the first mobile device receiving the identification code via wireless communication with the wireless tag of the physical collectible.

18. The computer readable media of claim 14, wherein, to retrieve the recorded data from the blockchain, the instructions, when executed, further cause the one or more machines to collectively:
index the blockchain to identify a most recent block in the blockchain;
index cache to identify whether the most recent block in the blockchain has already been indexed; and
retrieve the recorded data from the most recent block in the blockchain in response to determining that the most recent block has yet to be indexed.

19. The computer readable media of claim 14, wherein the instructions, when executed, further cause the one or more machines, upon identifying that a minting event is recorded on the blockchain, to collectively:
store identification data of the non-fungible token that was minted; and
store token data of the non-fungible token that was minted in a digital wallet of the collector.

20. The computer readable media of claim 14, wherein the instructions, when executed, further cause the one or more machines, upon identifying that a transfer event is recorded on the blockchain, to collectively:
store metadata of the transfer event; and
store token data of the non-fungible token that was transferred in a digital wallet of the collector.
